(19) United States
(12) Patent Application Publication
(10) Pub. No.: US 2022/0356863 A1
(43) Pub. Date: Nov. 10, 2022

(54) Energy conversion device

(71) Applicant: Tatsuya SHINTANI, Sakurai-shi (JP)

(72) Inventor: Tatsuya SHINTANI, Sakurai-shi (JP)

(21) Appl. No.: 17/619,264

(22) PCT Filed: Jun. 23, 2020
(86) PCT No.: PCT/JP2020/024682

§ 371 Date: Dec. 15, 2021

(30) Foreign Application Priority Data
Jun. 15, 2019 (JP) 2019-124035
Jun. 19, 2019 (JP) 2019-127210
Jun. 23, 2019 (JP) 2019-128808
Oct. 23, 2019 (JP) 2019-208293
Dec. 7, 2019 (JP) 2019-233537
Jun. 15, 2020 (JP) PCT/JP2020/023488

(51) Int. Cl. F03B 17/02; H02S 10/10; F03B 17/06; F03B 13/14

(52) U.S. Cl. CPC F03B 17/02; H02S 10/10; F03B 17/06; F03B 13/144; F05B 2210/401

(57) ABSTRACT

An energy conversion apparatus 1 comprises: a liquid tank 11 in which a liquid 10 is stored; a plurality of gas-receiving parts 12 that are provided in the vertical direction inside the liquid tank 11 and are free to rotate or move vertically; a nozzle 13 that, inside the liquid tank 11, ejects compressed gas from below the lowest positioned gas-receiving part 12; a gas cylinder 14 that stores compressed gas serving as a primary energy source and feeds the compressed gas to the nozzle 13; an output means 3 that outputs kinetic energy of rotation or vertical movement as secondary energy to the exterior of the liquid tank 11, the kinetic energy being generated in the gas-receiving parts 12 by a buoyant force that the gas-receiving parts 12 generate as a result of receiving the compressed gas ejected from the nozzle 13; and a recovery device 4 that returns the gas from the liquid tank 11 to the gas cylinder 14.

### TECHNICAL FIELD

The present invention relates to an energy conversion device that converts and generates secondary energy based on primary energy.

### BACKGROUND TECHNOLOGY

Gasoline engines, for example, are known as energy conversion devices.

### DISCLOSURE OF INVENTION

However, conventional devices of this kind are expensive in terms of carbon dioxide emissions and gasoline production.

The present invention solves the above problem, and aims to provide an energy conversion device capable of efficiently generating and converting secondary energy from primary energy.

An energy conversion device in accordance with one aspect of the present invention comprises a liquid tank in which a liquid is stored, a plurality of gas receiving sections installed vertically in said liquid tank that can rotate or move up and down freely, a nozzle in said liquid tank that ejects compressed gas from below said gas receiving section located at the bottom, a gas cylinder that stores said compressed gas as an energy source and delivers said compressed gas to said nozzle, and a gas receiver section that receives said compressed gas ejected from said nozzle. A gas cylinder that stores said compressed gas as an energy source and delivers said compressed gas to said nozzles, a gas receiving section that receives said compressed gas ejected from said nozzles and generates kinetic energy of rotation or upward movement in said gas receiving section due to the buoyancy force generated by said compressed gas. The output means to output as secondary energy to the outside of the tank, and the recovery device to return the gas from the liquid tank to the gas cylinder.

According to this configuration, compressed gas as a primary energy source is spewed into the liquid tank where the liquid is stored, the moving energy due to the buoyancy force generated is converted into secondary energy, and the gas is collected from the liquid tank into a gas cylinder for reuse, so that energy can be generated and converted efficiently.

The car body moving device is also characterized in that it is equipped with a car body, a sled for sliding on ice provided on the front, rear, left and right sides of the underside of the car body, rails with an ice surface formed by freezing liquid, which are provided on the road surface and guide the sled's sliding on ice, and a driving device to run the car body.

With this configuration, inertial motion can be performed by sliding on ice with less resistance, increasing the energy efficiency of driving.

Also, an energy utilization device according to one aspect of the present invention is an energy utilization device for utilizing energy of constant temperature groundwater, comprising: an underground tank for storing constant temperature groundwater buried in a predetermined underground location from which it is possible to obtain constant temperature groundwater; a structure comprising a plurality of hollow tubes made of a light transmissive material connected to each other to form an internal cavity; and a pipe for distributing constant temperature groundwater stored in the underground tank to the hollow tubes of the structure. The structure consists of a cavity formed inside by connecting a plurality of hollow tubes made of light-permeable material, a pipe and a circulation pump for distributing the constant-temperature groundwater stored in the underground tank to the hollow tubes of the structure, and a pump for circulating the constant-temperature groundwater from one end to the other in the cavity formed by the structure. The cavity is used as an air conditioning space or a space for installing energy exchange equipment.

This configuration allows for the effective use of energy from groundwater at constant temperature.

Another type of energy utilization device is an energy utilization device that utilizes energy from a constant-temperature underground, and is provided with a hollow pipe that reciprocates between the underground at a predetermined depth, which is a predetermined constant temperature, and the surface of the earth, and a fan that feeds air from the surface side into said hollow pipe. The air fed into the hollow pipe by the fan and cooled or heated at the predetermined depth underground is used for air conditioning at the surface side.

This configuration allows for the effective use of energy from groundwater at constant temperature.

Also, an energy utilization device according to another aspect, of the present invention is an energy utilization device using sunlight energy, comprising a structure comprising a plurality of hollow tubes made of a light transmissive material connected together to form an internal cavity, a pipe and a circulation pump for distributing water or hot water to the hollow tubes of said structure, and a fan for blowing air from one opening to another opening in said cavity formed by said structure. The structure is installed in a place where it can receive sunlight, and the seawater is passed through the bottom side of the cavity, and the wind from the fan is passed over the top of the seawater. The airflow by the fan is passed through the cavity to promote the evaporation of seawater to obtain salt.

With this configuration, sunlight energy can be used effectively.

Another type of energy utilization device of the present invention is an energy utilization device that uses compressed air for air conditioning, and is equipped with an air compression compressor powered by natural energy, and a tank buried underground that stores the air compressed by the air compression compressor. The compressed air stored in the tank and adjusted in temperature is delivered to the air-conditioning space through pipes.

With this configuration, natural energy can be used effectively and energy can be stored in the form of compressed air.

Another type of energy utilization device of the present invention is an energy utilization device that generates electricity using natural energy, and is characterized in that it has a wall structure installed on a beach that simulates a rias coast where seawater is forced to rise to a position higher than the sea surface by the force of ocean waves, and a tank that introduces and stores the seawater raised by the wall structure. The system is characterized by a tank that introduces and stores the seawater that has been raised by the wall structure, and a hydroelectric generator or air compression compressor that generates electricity using the potential energy of the seawater stored in the tank.

According to this configuration, the kinetic energy of seawater can be effectively utilized.

### BRIEF DESCRIPTION OF THE DRAWING

FIG. 1 Schematic of an energy conversion device according to one embodiment of the invention.

FIG. 2(a) shows the gas receiving section of the device in an open state, and FIG. 2(b) shows the same section in a closed state.

FIG. 3 shows Configuration of an energy conversion device for another embodiment of the invention.

FIG. 4 shows Configuration of an energy conversion device according to yet another embodiment of the present invention.

FIG. 5 shows Configuration of an energy conversion device according to yet another embodiment of the present invention.

FIG. 6 shows Configuration of an energy conversion device according to yet another embodiment of the invention.

FIG. 7 shows a diagram of a compressed gas generator for one embodiment of the energy conversion device of the present invention is shown, where (a) shows the operation in the compression process and (b) shows the operation in the inhalation process.

FIG. 8 shows Another compressed gas generator used in the energy conversion device of the present invention.

FIG. 9 shows Configuration of an energy conversion device according to yet another embodiment of the present invention.

FIG. 10 shows Illustration of the process of circulating operating gas in an energy conversion device according to an embodiment of the present invention.

FIG. 11 shows Configuration of an energy conversion device according to yet another embodiment of the present invention.

FIG. 12(a) shows the sledding state of the vehicle body moving equipment of one embodiment, of the present invention.

FIG. 12(b) shows the wheel running state of the same car body moving unit.

FIG. 13 (a) and FIG. 13(b) are side views, respectively, of a car body moving device for another embodiment of the invention.

FIG. 14 (a) shows Front view and FIG. 14(b) shows side view of the braking system for one embodiment of the vehicle body movement system.

FIG. 15 shows Schematic of an energy utilization device.

FIG. 16 shows Diagram of the device in use.

FIG. 17 shows another example of the same device.

FIG. 18 is a Schematic view of an energy utilization device for yet another embodiment of the invention.

FIG. 19 shows a diagram of an energy utilization device for yet another embodiment of the invention.

FIG. 20 shows a Diagram of an energy utilization device for yet another embodiment of the invention.

FIG. 21 (a) shows side view of an energy utilization device for yet another embodiment of the present invention, FIG. 21 (b) shows Plan view of the same device.

FIG. 22 shows a device that uses geothermal heat and other energy.

### FORM FOR IMPLEMENTING THE INVENTION

(Energy Conversion Device)

An energy conversion device according to one embodiment of the present invention will be described below with reference to the drawings. As shown in FIG. 1, the energy conversion device 1 has a liquid tank 11, a gas receiving section 12, a nozzle 1 3, a gas cylinder 14, an output means 3, and a recovery device 4. This energy conversion device is designed to blow compressed gas as a primary energy source into a liquid tank 11 in which liquid 10 is stored, and to convert the resulting buoyancy-induced moving energy into a secondary energy source that can be output from the liquid tank 11. The energy conversion device 1 is a device that converts the moving energy caused by buoyancy into secondary energy that can be output from the liquid tank 11.

The liquid tank 11 is a sealable tank and is usually used in a sealed state. Liquid 10 is stored in the tank 11. For example, water is suitably used as the liquid 10, but any liquid can be used, not limited to water. The size of the liquid tank 11 is, for example, 2 to 3 meters, but is not limited to this. Inside the liquid tank 11 is a power mechanism 31 that uses the buoyancy force of the liquid 10 to generate rotational motion. The power mechanism 31 consists of a belt 31a arranged in a ring shape that is long in the vertical direction, and two belts 31a The power mechanism 31 is equipped with a belt 31a arranged in a long ring shape in the vertical direction, two gears 31b on which the belt 31a is The upper gear 31b rotates when the belt 31a moves. The upper gear 31b is buried in the liquid 10 in FIG. 1, but its upper part may extend above the liquid surface. For example, the upper half of the gear may extend above the surface of the liquid. How much of the gear is exposed depends on the effectiveness of the buoyancy of the gas in the gas receiving section 12 and the resistance to the rotation of the gear 31b, such as the resistance of the liquid 1 For example, the resistance to the rotation of the gear 31b, such as the resistance of the liquid 1.0 to the gas receiving section 12, can be determined appropriately.

A plurality of gas receivers 12 are provided vertically in the liquid tank 11 by being distributed in a ring shape on the belt 31a. The gas receiving section 12 can move up and down in conjunction with the movement of the belt 31a. The gas receiving section 12 is freely movable up and down in conjunction with the movement of the belt 31a, and rotates in the upper and lower positions to perform a circumferential movement between the upper and lower positions as a whole. In this embodiment shown in FIG. 1, the belt 31a and gear 31b rotate clockwise, i.e., clockwise.

The nozzle 13 spews compressed gas from below the gas receiving section 12 located at the bottom in the liquid tank 11. The compressed gas is captured by the gas receiving section 12 and provides buoyancy to the gas receiving section 12. The gas receiving section 12 receives buoyancy from the liquid 10, but when it moves upward, it receives compressed gas ejected from the nozzle 13. When moving upward, it receives compressed gas ejected from the nozzle 13, and thus receives more buoyancy force than when moving downward. Although only one nozzle is shown in FIG. 1, there can be multiple nozzles. For example, like an upward-facing shower nozzle, the multiple openings of the nozzles are distributed over the entire surface of the downward-facing opening of the gas receiving section 12, so that gas can be emitted from a large area into the gas receiving section 12. For example, by distributing the multiple openings of the nozzles 13 over the entire surface of the downward opening of the gas receiving section 12, as in an upward-facing shower nozzle, gas may be emitted from a wide area into the gas receiving section 12.

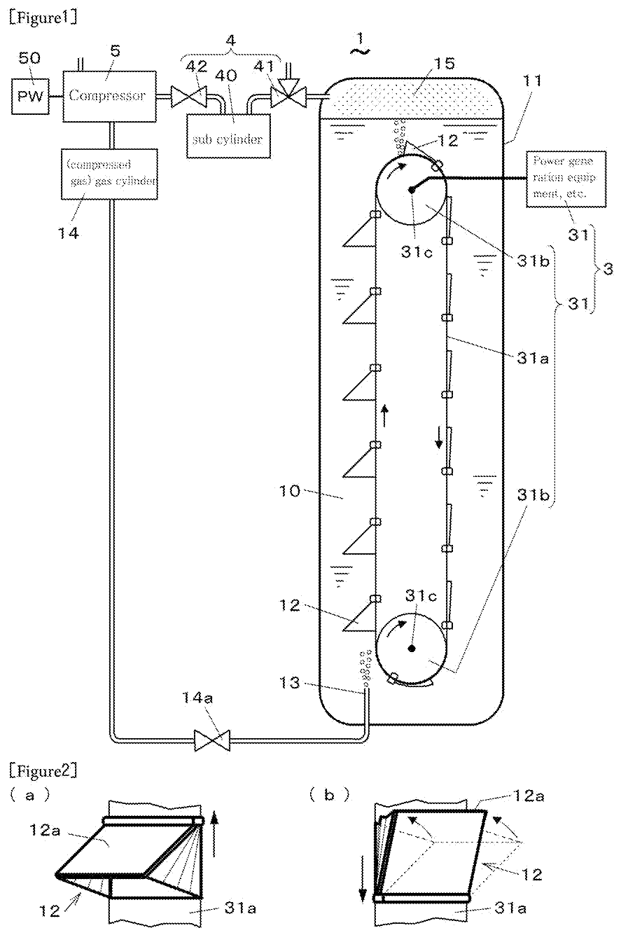

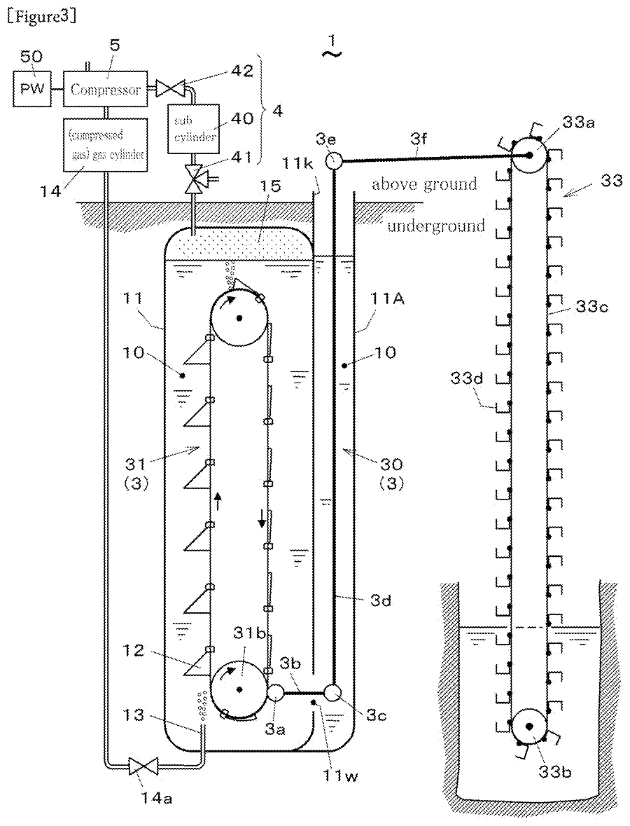

As shown in FIGS. 2(a) and 2(b), the gas receiving section 12 consists of movable wings 12a that can be opened and closed. As shown in FIGS. 2(a) and 2(b), the gas receiving section 12 is composed of movable wings 12a that can be opened and closed, and is in the open state when it receives compressed gas ejected from the nozzle 13 and generates buoyancy, and is in the closed state when it does not receive compressed gas and does not generate buoyancy from the gas. This structure allows the circumferential motion of the gas receiving section 12 and the belt 31a to be performed more efficiently.

The gas cylinder 14 stores compressed gas as a primary energy source and delivers the compressed gas to the nozzle 13. The gas cylinder 14 ejects the compressed gas from the nozzle 13 through a valve 14a that is controlled to open and close. The valve 14a is controlled to open only when the gas receiving section 12 is in place. This allows compressed gas to be efficiently supplemented to the gas receiving section 12, thereby reducing the consumption of compressed gas, and it also prevents air bubbles from mixing with the liquid 10, thereby maintaining a high density of the liquid 10. This also prevents air bubbles from mixing with the liquid 10, thereby maintaining the high density of the liquid 10 and making it possible to effectively use the buoyancy inherent in the liquid 10.

The gas cylinder 14 is connected to a compressed gas generator 5 that produces compressed gas. The compressed gas generator 5 can be, for example, a general compressor that converts mechanical energy into the energy of a fluid, gas, by pumping gas through the rotational motion of an impeller or rotor, or the reciprocating motion of a piston. The compressed gas generator 5 is powered by a power source 50. The power source 50 is natural energy, such as wind, geothermal, hydraulic, tidal, and wave power, which is suitable for suppressing the generation of greenhouse gases.

The compressed gas produced by the compressed gas generator 5 is a gas with increased pressure so that the gas can be supplied from the nozzle 113 to the gas receiving section 12 against the water pressure of the liquid 10 in the tank 11. The compressed gas generated by the compressed gas generator 5 is a gas with increased pressure so that the gas can be supplied from the nozzle 113 to the gas receiving section 12 against, the water pressure of the liquid 10 in the tank 11. The gas supplied to the gas receiving section 12 is supplied to provide buoyancy by the liquid 10 to the gas receiving section 12.

The output means 3 is a means of outputting the kinetic energy of upward movement due to buoyancy force generated in the gas receiving section 12 as secondary energy outside the liquid tank 11. The output means 3 is a means to output the kinetic energy of upward movement caused by buoyancy in the gas receiving section 12 as secondary energy outside the liquid tank 11. In this embodiment shown in FIG. 1, the output means 3 consists of a power mechanism 31 that converts kinetic energy from buoyancy into rotational energy of a rotating shaft 31c with a gear 31b. The output means 3 in this embodiment, shown in FIG. 1, is equipped with a power mechanism 31 that converts kinetic energy from buoyancy into rotational energy of the rotating shaft 31c of gear 31b, and a power generator 32 that converts rotational energy of the rotating shaft 31c into electrical energy as secondary energy. In the output method 3, the power mechanism 31 converts kinetic energy due to buoyancy into rotational energy of the rotating shaft 31c of the gear 31b.

The recovery device 4 is a device that returns gas from the liquid tank 11 to the gas cylinder 14. The upper space of the liquid tank 11 is a gas chamber 15 in which the gas stays. The recovery device 4 feeds the gas stagnating in the gas chamber 15 to the gas cylinder 14 via the compressed gas generator 5. The gas in the gas chamber 15 is the gas created from the nozzle 13 and the vapor of the liquid 10.

The recovery device 4 has a three-way valve 41, a sub-pombe 41, and a valve 42 along the conduit from the gas chamber 15 to the compressed gas generator 5. The three-way valve 41 and the valve 42 are controlled to open and close. The three-way valve 41 and valve 42 are valves for flow control and closing, controlled by opening and closing. It is desirable for this r to be a multi-functional valve with the function of a check valve.

The three-way valve 41 has the function of a valve for releasing gas to reduce the pressure in the gas chamber 15. The sub-pombe 40 functions as a buffer, assisting the capacity of the gas chamber 15.

If the compressed gas generator 5 has the functions of a three-way valve 41, a sub-pombe 40, and a valve 42, the recovery device 4 may consist only of piping connecting the gas chamber 15 to the compressed gas generator 5. If the compressed gas generator 5 has the functions of three-war valve 41, sub-pombe 40, and valve 42, the recovery device 4 may consist only of piping connecting the gas chamber 15 to the compressed gas generator 5.

Next, the operation of the energy conversion device 1 will be explained. The operating gas, or compressed gas, of the device will be described assuming that it is air, but it is not limited to air. The explanation will also assume that the liquid 10 is water. Water is injected into the liquid tank 11 in which the power mechanism 31 is installed, and pipes such as gas cylinder 14 are connected to the nozzle 13. Connect the piping of the recovery device 4 to the gas chamber 15, and operate the compressed gas generator 5 to prepare compressed gas. While adjusting the gas pressure in the gas chamber 15 with the three-way valve 41, and also while adjusting the valve 14a, the nozzle The compressed gas is delivered to 13.

The gas comprising the compressed gas that comes out of the upward opening of the nozzle 13 is captured by the gas receiving section 12 that opens at the bottom of the upwardly moving belt 31a and is replaced by water in the upper space of the gas receiving section 12. It is captured by the gas receiving section 12, which opens at the bottom of the upward moving belt 31a, and replaces the water in the upper space of the gas receiving section 12. Then, the buoyancy force based on the gas is added to the gas receiving section 12, and the difference in the force acting on the left and right belts 31a based on the buoyancy of the liquid 10 is reduced, a based on the buoyancy of the liquid 10, and the belt 31a gradually begins to rotate clockwise. When the gas is received by the gas receiving section 12, which moves one after another above the nozzle 13, the belt 31a's circumferential When the gas is received by the gas receiving section 12, which moves one after another above the nozzle 13, the belt 31a becomes stationary.

In the steady state of circumferential movement of the belt 31a, gas is released into information from the gas receiving section 12, which rotates with the belt 31a in contact with the upper gear 31b. In the steady state of circumferential movement of the belt 31a, gas is released from the gas receiving section 12, which rotates with the upper gear 31b, into the information. The gas receiving section 12, which has released gas, moves downward with its movable wings 12a closed. The gas receiving section 12, which rotates with the belt 31a in contact with the gear 31b on the lower side, moves downward. 2, which rotates with the belt 31a in contact with the lower gear 31b, opens and closes the movable wings 12a to receive gas from the nozzle 13. 3 to receive gas from the nozzle.

The circumferentially moving belt 31a converts the kinetic energy from the buoyantly rising gas receiver 12 into kinetic energy for the rotation of the gear 31b into rotational kinetic energy. The rotation of the gear 31b rotates the rotating shaft 31c, and the rotational energy becomes electrical energy generated by the power generator 3 The rotation of gear 31b rotates the rotating shaft 31c, and the rotational energy is extracted externally as electrical energy generated by the generator 31. Of course, this energy can also be used to directly drive gears and turn the ship's screws.

The relationship between the three pressures P1, PW, and P2 will now be explained. Pressure P1 is the pressure of the compressed gas delivered from the gas cylinder 14. Pressure PW is the water pressure determined by the depth of the liquid 10. Pressure P2 is the pressure of the gas in the gas chamber 15. These pressures are related by the following equation when the energy conversion device 1 is operating in a steady state. This equation shows the conditions under which the gas from the gas cylinder 14 can enter the liquid 10 through the nozzle 13.

P2+PW<P1

However, when releasing the gas into the liquid, it is possible to make the diameter of the release pipe extremely small to create microbubbles, or to install multiple pipes through which the gas passes to move the gas into the space where the weight is added by water, etc. even at extremely low pressure. Or, if the water pressure in the tank is only high enough to allow liquid butane to flow from the tip of the pipe and become a gas, the butane can be efficiently vaporized.

The compressed gas generator 5 compresses the gas to obtain the required pressure P1, which is at least as high as the water pressure PW. The recovery unit 4 opens and closes the three-way valve 41 to adjust the pressure of the gas in the gas chamber 15 so that the above equation is satisfied. 2in the gas chamber 15 so that the above equation is satisfied.

In this energy conversion device, compressed gas circulates through the device while undergoing pressure fluctuations as the working gas. In a steady state, the energy conversion device 1 forms a closed circulation circuit of the working gas. In order to adjust the pressure of the working gas of the working gas, various valves, pressure sensors, tanks, and other components may be incorporated into the energy conversion device 1 as appropriate.

According to the energy conversion device 1, compressed gas as a primary energy source is blown into the liquid tank 11 where the liquid 10 is stored, and the resulting The moving energy due to buoyancy is converted into secondary energy, and the gas is collected from the liquid tank 11 into a gas cylinder 14 for reuse. Therefore, energy can be generated and converted efficiently. When a special gas is used as the working gas, i.e. compressed gas, instead of air or other gases, the special gas can be recovered and reused. In addition, the gas in the gas chamber 15 can be used in the atmosphere, for example.

The pressure P2 of the gas in the gas chamber 15, or the pressure energy of the gas, can be reused because it is not opened to the

Next, another embodiment is described with reference to FIG. 3. The energy conversion device 1 of this embodiment has a transmission mechanism 30 that mechanically extracts the rotational energy of the gear 31 The energy conversion device 1 of this embodiment is equipped with a transmission mechanism 30 that mechanically extracts the rotational energy of the gear 31B to the outside. In this example, the liquid tank 11 is installed underground, but it is not limited to being installed underground, and may be grounded semi-subterranean or above ground. The same applies to the energy conversion device 1 shown in FIG. 1.

The transmission mechanism 30 comprises a coupler 3a, such as a gear, which engages the lower gear 31b of the power mechanism 31 and receives rotational energy therefrom; a shaft 3b, which in turn couples to the coupler 3a; a coupling 3b, which in turn couples to the coupling 3a; and a coupling 3a. The transmission mechanism 30 has a coupling 3a, such as a gear, which engages the lower gear 31b of the power mechanism 31 and receives rotational energy therefrom, a shaft 3b, a coupling 3c, a shaft 3d, a coupling 3e, and a shaft 3f, which are in turn coupled to the coupling 3a, c, shaft 3d, coupler 3e, and shaft 3f, which are in turn coupled to the coupler 3a.

The transverse shaft 3b is led out of the liquid tank 11 through a connecting opening 11w in the side wall of the liquid tank 11 located at the side of the lower gear 31b. The horizontal shaft 3b is led out of the liquid tank 11 through a connecting opening 11w in the side wall of the liquid tank 11 located at the side of the lower gear 31b. In addition, a water seal tank 11A is provided on the lateral exterior of the liquid tank 11 to enclose the coupler & and the longitudinal shaft 3d. 11A is provided. The water sealing tank 11A has a connecting opening 11w that connects with the inside of the liquid tank 11, and a top opening 11w that opens upward. The water-sealed tank 11A has a communication opening 11w that connects with the inside of the liquid tank 11, and an upper opening 11k that opens upward. The water-sealed tank 11A contains liquid 10, and its liquid level is opened to atmospheric pressure by the upper opening 11k. The liquid level is opened to atmospheric pressure by the upper opening 11k. The vertical relationship between the liquid level of the liquid 10 in the liquid tank 11 and the liquid 11 in the water-sealed tank 11A is The vertical relationship between the liquid level of the liquid 10 in the liquid tank 11 and the liquid 11 in the water-filled tank 11A are different from each other, when the pressure P2 of the gas in the gas chamber 15 is not atmospheric pressure.

The output mechanism 30 of the output means 3 in this energy conversion device 1 uses a water-sealed structure, so mechanical energy can be extracted outside the energy conversion device 1 without using a strict sealing structure. The output mechanism 30 of the output means 3 in this energy conversion device 1 uses a water-sealed structure so that mechanical energy can be extracted outside the device without using a strict sealing structure. The water-sealed structure can be applied to the upper gear 31b in the same way.

The transmission device 30 is a combination of these couplers 3a, 3c, 3e, and through shafts 3b. 3d, and 3f, which are converted and generated in the liquid tank 11. The energy is extracted as mechanical energy outside the energy conversion device 1 and transferred to an external operating device 33.

The operating device 33 is a pumping machine and consists of a chain 33c on upper and lower sprockets 33a, 33b. It consists of a plurality of buckets 33d on a chain 33c applied to upper and lower sprockets 33a, 33b. The rotational energy taken out of the energy conversion device 1 is transmitted as rotational energy to the upper sprocket 33a via the shaft 3f. The rotational energy taken out of the energy conversion device 1 is transmitted as rotational energy to the upper sprocket 33a via the shaft 3f.

According to this energy conversion device 1, energy based on the pressure of compressed gas can be converted into mechanical energy and output, and the mechanical energy can be used as it is for the mechanical operation of the motion device 33. The mechanical energy can be used as energy for the mechanical operation of the motion device 33.

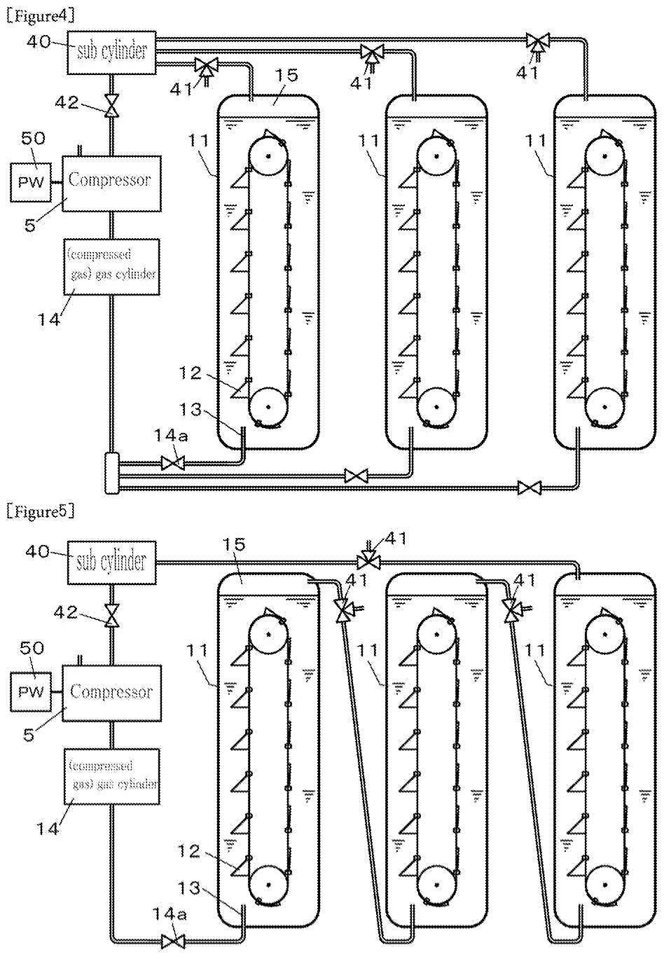

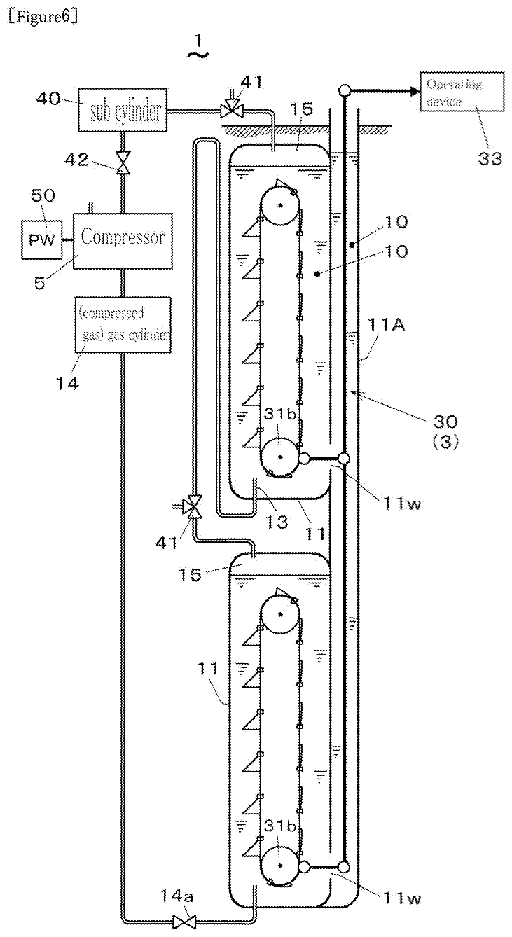

Next, referring to FIG. 4, FIG. 5 and FIG. 6, examples of combinations when multiple liquid tanks 11 are used are described. A plurality of liquid tanks 11 may be provided in parallel or in series with respect to gas cylinder 14. The energy conversion device 1 shown in FIG. 4 is an example of three liquid tanks 11 of the same structure as each other installed in parallel to a gas cylinder 14. The energy conversion device 1 shown in FIG. 4 is an example of three liquid tanks 11 of the same structure as each other installed in parallel to a gas cylinder 14. Compressed gas is delivered to the nozzles 13 of each liquid tank 11 through the valves 14 respectively. The gas in the gas chamber 15 of each liquid tank 11 is collected in a sub cylinder 40 through a three-way valve 41.

0. Parallel

The placed liquid tanks are not limited to the same structure as each other, but can be of different structures from each other, and the number of tanks is not limited to three.

The energy conversion device 1 shown in FIG. 5 is an example of three liquid tanks of the same structure as each other 11 in series with each other. Each liquid tank 11 is located at the same horizontal level. From the side closest to the gas cylinder 14, the first liquid tank 11 has a valve 14 The first liquid tank 11, from the side closest to the gas cylinder 14, has a valve 14A through which compressed gas is delivered to the nozzle 13. From the gas chamber 15 of that first liquid tank 11, through the three-way valve 41, the second. The gas is pumped from the gas chamber 15 of the first liquid tank 11 to the nozzle 13 of the second liquid tank 11 via the three-way valve 41. From the gas chamber 15 of the second liquid tank 11, gas is delivered to the nozzle 13 of the third liquid tank 11 via the three-way valve 41. The gas is pumped from the gas chamber 15 of the second liquid tank 11 to the nozzle 13 of the third liquid tank 11 through the three-way valve 41. The gas is then collected from the gas chamber 15 of the third liquid tank 11 into the sub cylinder 40.

Valve 14a and three three-way valves 41 are used to regulate the pressures corresponding to the pressures P1, PW, and P2 in the three liquid tanks 1 The valves 14a and the three three-way valves 41 are used to adjust the pressures corresponding to the pressures P1. PW, and P2 described above in the three liquid tanks 11 to each other. The liquid tanks arranged in series are not limited to those of the same structure as each other, but can be of different structures from each other, and the number of tanks is not limited to three.

The energy conversion device 1 shown in FIG. 6 is an example of two liquid tanks of the same structure as each other, 11 in series, above and below each other. Gas from the gas chamber 15 of the lower liquid tank 11 is delivered to the nozzle 13 of the upper liquid tank 11 through the three-way valve 41. The gas from the gas chamber 15 of the lower liquid tank 11 is pumped through the three-way valve 41 to the nozzle 13 of the upper liquid tank 11. The piping leading the gas is piped to the upper level of the upper liquid tank 11, and then pulled back to the bottom of the liquid tank 11, where it is connected to the nozzle 13. 3. This piping structure is to prevent, the liquid 10 from the upper liquid tank from flowing into the lower liquid tank 11 through the gas piping.

The upper and lower liquid tanks 11 are connected to each other by the water seal tank 11A. In this embodiment, a configuration is realized in which mechanical energy is extracted from the upper and lower liquid tanks 11 via the water-sealed tank 11A and the transmission mechanism 3.0, which are common to each other. In this embodiment, a configuration in which mechanical energy is extracted from the upper and lower liquid tanks 11, respectively, via the common water-sealed tank 11A and transmission mechanism 3.0 is realized. The upper and lower liquid tanks are not limited to being connected to each other by the water seal tank 11A. 1 may be independent of each other. For example, the pair of liquid tanks 11, water seal tank 11A, and transmission mechanism 30 shown in FIG. 3 can be connected in series to each other. In this case, the upper and lower liquid tanks are equipped with their own water seal tanks 11A and transmission mechanisms 30. In this case, the upper and lower liquid tanks 11A and the transmission mechanism 30 are provided.

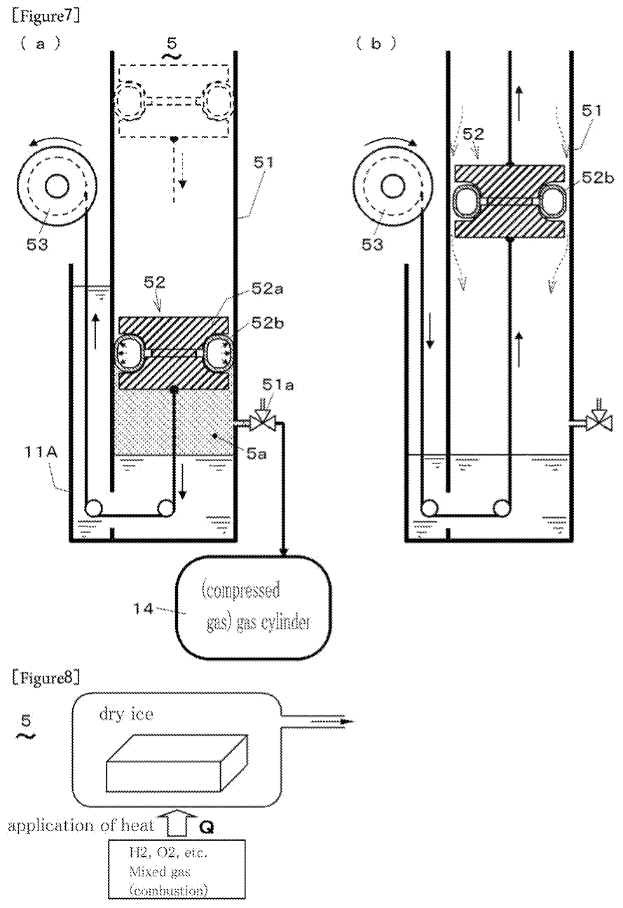

Next, referring to FIGS. 7(a) and (b), an example of a compressed gas generator 5 will be described. This compressed gas generator 5 generates compressed gas by pressurizing gas using a pressurizing piston 52 provided in a cylinder 51. The pressurizing piston 52 has a piston body 52a and a sealing material 52b consisting of a floating ring-shaped O-ring that can adjust the internal pressure. 2b.

The lower side wall of the cylinder 51 has an open connection to the piping for creating compressed gas. The piping is connected to the gas cylinder 14 through a three-way valve 51a. The lower part of the cylinder 51 is connected to a water-sealed tank 11A, which is installed outside the side wall of the cylinder 51 by means of a water-sealed structure. A. The lower part of the cylinder 51 is connected to the water-sealed tank 11A by a water-sealed structure. A chain is attached to the lower surface of the pressure piston 52, and the chain is wound up and rewound freely through the water-sealed structure to the hoisting machine 53 located above the water-sealed tank 11A. The chain is fixed to the winder 53, which is located above the water seal tank 11A through the water seal structure and can be wound up and down freely.

In the pressurization process, as shown in FIG. 7(a), the internal pressure of the floating ring-shaped sealing material 52b is increased to create a slidable sealing structure between the pressurized piston 52 and the inner wall of the cylinder 51. Next, the pressurizing piston 52 is moved downward by the hoisting machine 53 to compress the gas inside the cylinder 51, and the compressed gas is delivered to the gas cylinder The compressed gas is delivered to the gas cylinder.

In the intake process, as shown in FIG. 7(b), the internal pressure of the floating ring-shaped sealing material 52b is weakened to create a structure with a gap between the pressurized piston 52 and the inner wall of the cylinder 51 with a gap between them. Next, loosen the hoist 53 and pull the pressurizing piston 52 upward to inhale gas inside the cylinder 51.

The mechanism and energy used to push the pressure piston 52 downward to compress the gas is not limited to the use of the hoisting machine 53, but various methods can be used. For example, hydraulic pressure or water pressure can be applied to the upper surface of the pressurized piston 52 instead of the water seal structure and the hoisting machine 53. The intake process can be easily carried out by lowering the internal pressure of the floating ring-shaped sealing material 52b, whose internal pressure can be adjusted.

Next, referring to FIG. 8, another example of a compressed gas generator 5 will be described. In this compressed gas generator 5, individual dry ice is heated by the heat of combustion of a mixture of gas containing hydrogen and oxygen to become a gas, which is then expanded in volume to produce the aforementioned compressed gas. The generated compressed gas is pumped out of the gas cylinder 14. In general, the operating gas should be a gas that produces buoyancy when delivered from the nozzle 13. For example, it may be in a liquid or solid state instead of a gas during the process from the gas chamber 15 to the gas cylinder 14. An operating gas that, is converted into an individual or liquid by being made into dry ice or liquefied gas after the recovery unit 4 can be used. For example, a substance that is compressed to become a liquefied gas may be used as the operating gas.

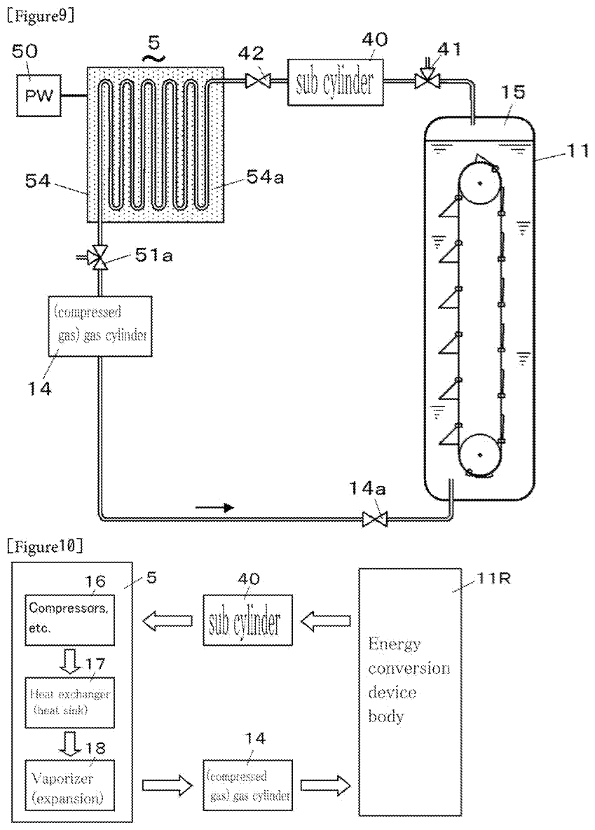

Next, with reference to FIG. 9, another example of an energy conversion device 1 will be described. In this energy conversion device 1, the compressed gas generator 5 generates compressed gas by passing the gas piping through a heat exchanger 54 to heat the gas, and is otherwise similar to the energy conversion device 1 of Figs. The rest of the device is the same as the energy conversion device 1 in FIGS. 1 and 3. On the upstream side of the heat exchanger 54, that is, on the sub cylinder 40 side, there is a valve 42 that functions as a check valve.

In addition, downstream of the heat exchanger 54, that is, on the gas cylinder 14 side, a three-way valve 51 a is provided downstream of the heat exchanger 54. i.e., on the gas cylinder 14 side, as necessary.

In this compressed gas generator 5, a heat medium 54a, which becomes hot, is enclosed in the housing of the heat exchanger 54. The pipes leading to the operating gas that circulates in the energy conversion device 1 and operates the energy conversion device 1, that is, the gas that becomes the compressed gas, are surrounded by the heat medium 54a in the heat exchanger 54. 4a inside the heat exchanger 54. The operating gas inside the piping is converted into high-pressure gas by receiving heat from the heat medium 54a, and becomes compressed gas. The working gas does not have to be always in a gaseous state while circulating in the energy conversion device 1, but can be in a liquid or solid state. When the working gas in a state different from that of gas is included in the general term, it is called the working gas material.

The heat, exchanger 54 may, for example, contain metallic sodium as a heat medium 54a with a high boiling point in the form of a solar water heater. The heat exchanger 54 may use natural energy to heat the heat medium 54a. The natural energy may be, for example, solar energy, geothermal heat (such as heat from magma), heat from thermal springs, etc.

In addition, the substance that serves as the operating gas depends on the combination with the liquid 10 in the liquid tank 11, and also on the operating conditions of the energy conversion device 1, such as various pressure P1, PW, P2, temperature conditions of the liquid 10, physical properties during operation, and the like. For example, the operating gas may be CFCs or other gases. For example, a refrigerant such as Freon may be used as the operating gas. For example, a refrigerant such as chlorofluorocarbon may be used as the operating gas, and ammonia water may be used as the liquid 10 in addition to water.

Next, with reference to FIG. 10, the circulation process of the operating gas in one embodiment of the energy conversion device 1 will be schematically described. In the energy conversion device 1 of this embodiment, the operating gas is made into high-pressure gas by the compressed gas generator 5, and is delivered to the main body 11R of the energy conversion device via the gas cylinder 14. The gas is sent to the main body of the energy conversion device 11R via the gas cylinder 14, collected from the main body 11R into the sub cylinder 40, and then returned to the compressed gas generator 5. It is then collected in the sub cylinder 40 and returned to the compressed gas generator 5. The main body of the device 111R is the general term for the entire liquid tank 11 and its internal structure, and after converting the primary energy of the compressed gas into kinetic energy, it is sent outside the liquid tank 11 as secondary energy. After the primary energy from the compressed gas is converted into kinetic energy, it is output to the outside of the tank as secondary energy.

The compressed gas generator 5 of this embodiment, has a compressor 16, a heat exchanger 17, a vaporizer 18. Here, CFCs, which are used as refrigerants in refrigeration equipment, will be assumed as the operating gas. Such a working gas can be used as a heat source when it is heated to a high temperature, can be used as a heat absorber when it is cooled down by expanding and emitting heat of vaporization, and can be used as a gas that provides buoyancy to the gas receiving section 1.2 in the energy conversion device 1 by being made into a high-pressure gas. When the gas is made into a high-pressure gas, it can also be used as a gas that provides buoyancy to the gas receiving section 1.2 in the energy conversion device 1.

Compressor 16 compresses the operating gas to a high temperature and high pressure state using, for example, electrical energy. The heat exchanger 17 releases the heat of the operating gas inside it to heat a liquid or gas, such as water, air, or the like. The heated liquid or gas is led elsewhere and used for heating in air conditioning.

The vaporizer 18 is further lowered in temperature by expanding the operating gas through an expansion valve or other means. The lower temperature operating gas can take away heat from the surrounding area, and its heat absorption capacity is used in the construction of cooling systems. After passing through the heat exchanger 17 and the vaporizer 18, the operating gas becomes compressed gas with moderately adjusted pressure, and is delivered to the main body of the device 11R via the gas cylinder 14. The gas is then delivered to the main body of the equipment via gas cylinder 14 for energy conversion.

According to such a circulation process, excess energy can be fed into the operating gas in advance in the compressor 16, and the excess energy can be used in the subsequent heat exchanger 17 and vaporizer 1 In the subsequent heat exchanger 17 and vaporizer 1.8, the surplus energy can be used for heating and cooling, respectively, and then energy conversion using buoyancy can be performed. In an environment where surplus energy can be input, a unified system can be constructed as a whole.

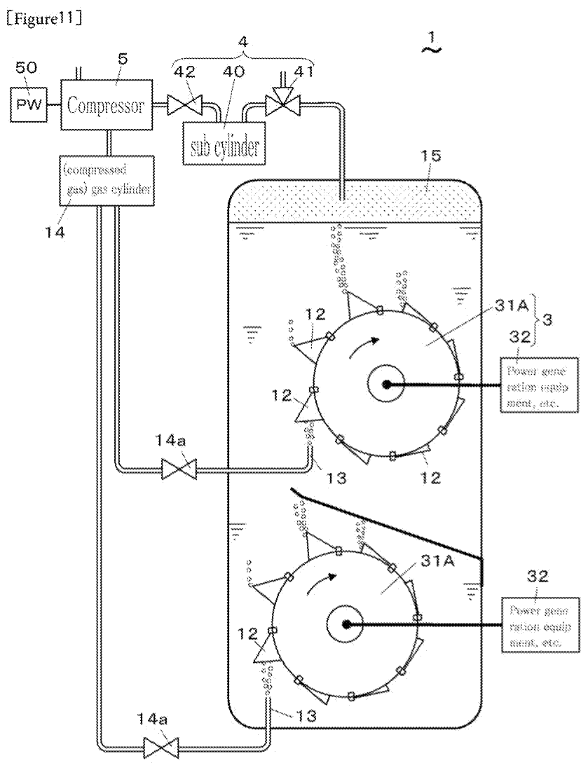

Next, with reference to FIG. 11, another embodiment of the energy conversion device 1 will be described. In this embodiment of the energy conversion device 1, the power mechanism 31 in the energy conversion device 1 of FIG. 1 is replaced by a power mechanism 31A having the appearance of a water turbine. This embodiment of energy conversion device 1 replaces the power mechanism 31 in the energy conversion device 1 of FIG. 1 with a power mechanism 3A that has the appearance of a water turbine. The power mechanism 31A has a plurality of gas receiving parts 12 around the circumference of a rotating body that rotates around an axis. The gas receiving section 12 has the structure shown in FIGS. 2 (a) and (b).

In this embodiment, two power mechanisms 31A that rotate clockwise are installed in the liquid tank 11. For each power mechanism 31A, a valve 14a and a nozzle 13 are set respectively. For each power mechanism 31A, a valve 14a and a nozzle 13 are set respectively. The rotational energy of the power mechanism 31A is converted into electrical energy by the power generator 32.

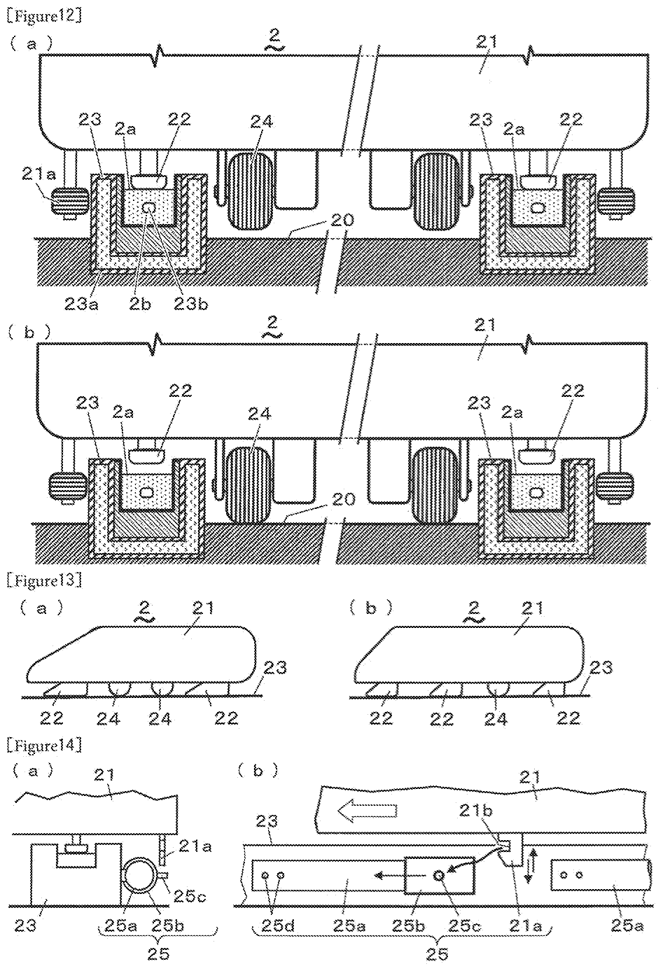

(Car body moving device) Next, referring to the drawings, we will describe a car body moving device according to one embodiment of the invention. As shown in FIGS. 12(a) and 12(b), the car body moving device 2 consists of a car body 21, a sled 22 for sliding on ice provided on the front, rear, and left sides of the underside of the car body 21, and a sled 20 on the road surface. As shown in FIGS. 12(a) and 12(b), the car body moving device 2 consists of a car body 21, a sled 22 for sliding on ice provided on the front, rear, left and right sides of the lower surface of the car body 21, and a sled 22 on the road surface 20. The sled 22 is equipped with a pair of rails 23 on the left and right sides of the road surface 20, on which the ice surface 2a is formed by freezing liquid to guide the sled 22 on the ice, and a drive unit to drive the car body 21. The sled 22 is equipped with a pair of rails 23 on the left and right sides, on which the ice surface 2a is formed by freezing liquid to guide the sled 22 on the ice, and a drive unit to run the car body 21.

The rail 23 has a concave cross-section with grooves in the longitudinal direction and is fixed to the road surface 20. The enclosure 23a has a concave cross-section with grooves in the longitudinal direction and is fixed to the road surface 20, and a refrigerant tube 23b that passes refrigerant placed inside the grooves. The groove of the enclosure 23a is filled with water, which is cooled by the refrigerant tube 23b to form ice 2 b is formed. The surface of the ice 2b becomes the ice surface 2a for the sled 22 to slide on the ice. The rails 2:3 may be equipped with a cover to prevent rain from entering the interior when the sled 22 is not sliding on ice. The rail 23 may also be equipped with drain holes to drain water present on the ice surface 2a. This cover and the enclosure 23a of the rail 23 are cooled, etc., by pipe circulation of underground tank water.

A guide wheel 21a is provided in close proximity to the outer surface of the rail 23. The guide wheels 21a guide the car body 21 so that it runs along the rails 23. Such a guiding device may be provided between the sled 22 and the rails 23. For example, to prevent the sled 22 from deviating from the rails 23, a structure at the rails 23 may be used to wrap and enclose the sled 2 For example, the structure in the rails 23 may be configured to wrap around and enclose the sled 2.2 to prevent the sled 22 from deviating from the rails 23.

The driving device is a wheel 24 powered by an engine or motor mounted on the car body 21. The wheels 24 are configured to be raised and lowered freely with respect to the vehicle body 21, and when not in drive, they are moved upward to move away from the road surface 20. 21 is sledded on the ice surface 2a by the sled 22 (FIG. 12). In addition, when the wheels are driven, they contact the road surface 20 and drive the vehicle body 21 on wheels (FIG. 1). 3).

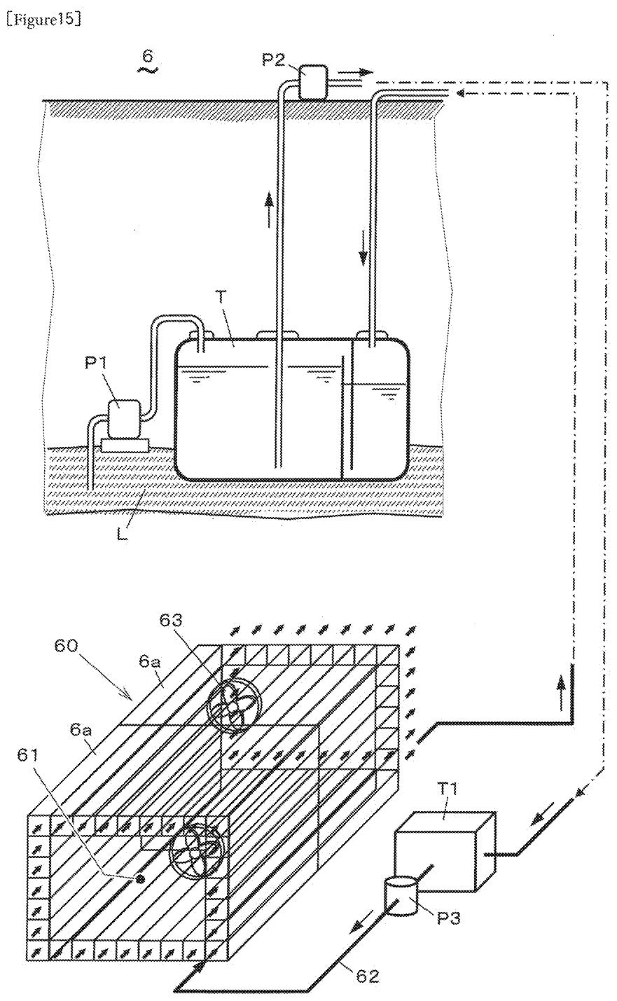

The wheels 24 are located between the front and rear sleds 22 in the front-to-back direction, as shown in FIG. 13(a). Two wheels may be arranged in a row, or one in the front-back direction as shown in FIG. 13(b). The arrangement and number of wheels 24 can be set arbitrarily according to the respective roles of sled running and wheel running. For example, when the sled 22 is grounded on the ice surface 2a and run by the wheels 24, the weight of the vehicle body 2 For example, when the sled 22 is grounded on the ice surface 2a and the wheels 24 are used to drive the vehicle, the weight of the vehicle body 21 is supported by the sled 22, so the wheels 24 only need to drive the vehicle, and only one wheel is needed in total. When the weight of the car body 21 is supported by the wheels 24, a three-point support. In order to do this, at least three wheels are needed.

The car body moving device 2 may be implemented to travel and move the car body 21 using a drive device that does not have wheels 24. For example, a jet propulsion device or a propeller propulsion device may be used as a drive device mounted on the vehicle body 21. A linear motor may also be used as the driving device. In this case, the lines that form the magnetic field of the linear motor may be covered with a frozen liquid to form an ice surface. The linear motor and the wheels 24, which are driven by an engine or motor mounted on the vehicle body 21, may be combined as a drive unit.

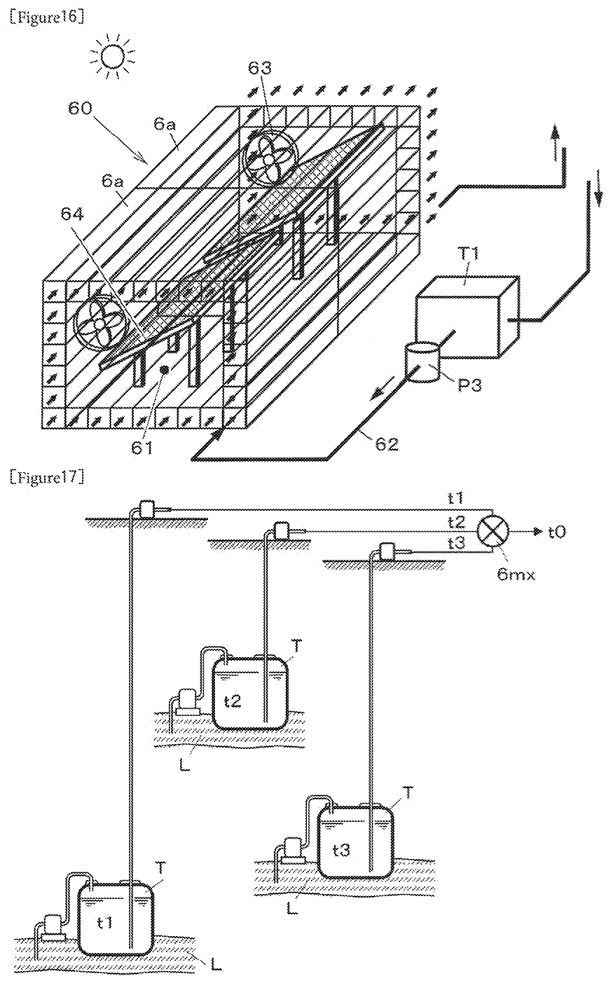

Referring to FIGS. 14 (a) and (b), the braking device for one embodiment of the car body moving device 2 is described. The vehicle body 21, which is sliding on ice on rails 23 using a sled 22, is slowed or stopped by absorbing its kinetic energy with a braking device. The vehicle body is slowed or stopped by absorbing its kinetic energy with a braking device. The car body moving device 2 can be equipped with any braking device.

The braking device 25 in this embodiment absorbs kinetic energy by means of fluid movement resistance. The braking device 25 is an application of a device commonly referred to as a shock absorber or damper.

The braking device 25 is provided along the rail 23 and consists of, for example, a cylinder 25a filled with liquid, a piston 25b that moves relative to the cylinder 25a and moves the liquid inside. The braking device 25 is provided along the rail 23 and consists of, for example, a cylinder 25a filled with a liquid, a piston 25b that moves relative to the cylinder 25a to move the liquid inside, and a stopper 26c on the piston 25b. The piston 25b moves relative to the cylinder 25a to move the liquid inside, and the piston 25b has a stopper 26c. The piston 25b moves relative to the cylinder 25a and the piston 25b to move the liquid inside. The cylinder 25a and the piston 25b have the structure and function of a shock absorber. The pairs of cylinders 25a and pistons 25b are arranged at predetermined intervals along the rails 23. The pairs of cylinders 25a and pistons 25b are located at predetermined intervals along the rail 23. The pairs of cylinders 25a and pistons 25b may be arranged at predetermined intervals along the entire line of the rail 23. The pairs of cylinders 25a and pistons 25b may be arranged at predetermined intervals along the entire line of the rail 23, or at predetermined intervals within a predetermined range.

When braking, it is lowered from the running car body 21 downward to engage with the stopping portion 2 When braking, it is lowered down from the running car body 21 to engage the stopping section 2.6c and push the stopping section 26c in the running direction (to the left in the figure). As a result, the piston 25b is pushed to the left and moves, and the viscous resistance of the oil converts and absorbs the kinetic energy into thermal energy, thereby decelerating the car body 21.

The braking device 25 has a plurality of safety valves 25a and 25d to relieve the pressure in the cylinder 25a to prevent destruction. The braking device 25 is equipped with a plurality of safety valves 25d to release the pressure in the cylinder 25a to prevent destruction. Those safety valves 25d are set to function in stages, depending on the pressure stage. If the car body 21 cannot be stopped within the moving range of the piston 25bi, the engagement part 26c and the engagement part. If the car body cannot be stopped within the movable range of the piston 25b, the engagement between the stopping portion 26c and the engaging portion 21b is automatically released, and the stopping portion in the next stage of the cylinder 25a and piston 25b in the traveling direction is automatically released. In the case of a failure to stop, the engagement part 21b is automatically released from the engagement part. 26c and the engagement part 21b is engaged to the engagement part 26c of the next pair of cylinders 25a and pistons 25b in the direction of travel. The braking action by the pair is performed. In accordance with the predetermined rules of travel speed and braking distance, the brake is activated. Thus, the braking system 25 is set up and placed.

(Energy Utilization Equipment) Next, referring to FIG. 15, we will describe the energy utilization device 6 of one embodiment of the invention. The energy utilization device 6 is a device that utilizes the energy of groundwater at constant temperature. The energy utilization device 6 consists of an underground tank T, a structure 60, a pipe 62 and a circulation pump P 3, and a fan 63.

An underground tank T is buried in a predetermined underground location where a predetermined constant temperature groundwater can be obtained to store the constant temperature groundwater. The underground tank T is located, for example, near the groundwater layer L, containing the constant-temperature groundwater, together with a pump P1, and stores the groundwater pumped by the pump P1. The underground tank T stores the groundwater pumped up by the pump P1. The groundwater is pumped up to the surface from the tank T by pump P2.

The structure 60 has a cavity 6a formed by interconnecting a plurality of hollow tubes 6a made of light transmissive material. 1 inside the structure. The cavity 61 is used as an air-conditioning space or an energy exchange equipment installation space. The structure 60 may, for example, be installed above ground if it is used in the presence of sunlight, or underground in other cases. In the case of underground, it is easier to use the structure under a given constant temperature. The structure 60 is used as an enclosed space by sealing both ends of it with walls formed by connecting hollow tubes 6a. The structure 60 may be used as an open space with both ends of the structure partially open.

Pipe 62 and circulation pump P3 are used to distribute constant temperature groundwater stored in underground tank T and pumped by pump p2. The pipes 62 and the circulation pump P3 are used to distribute the constant temperature groundwater stored in the underground tank T and pumped by the pump p2 into the hollow tube Ga of the structure 60. The groundwater is stored in the auxiliary tank T1 only as much as required, circulated through the hollow tube 6a, and then returned to the underground tank T This circulation in the hollow tube 6a results in a constant temperature inside the cavity 61. The fan 63 generates a flow of air into the sealed cavity 61 formed by the structure 60. This airflow eliminates the stagnation of air in the cavity 61. The structure 60 is equipped with external piping from one end to the other to form a closed wind passage, and the fan 63 creates a A unidirectional flow of air may be generated by the fan 63.

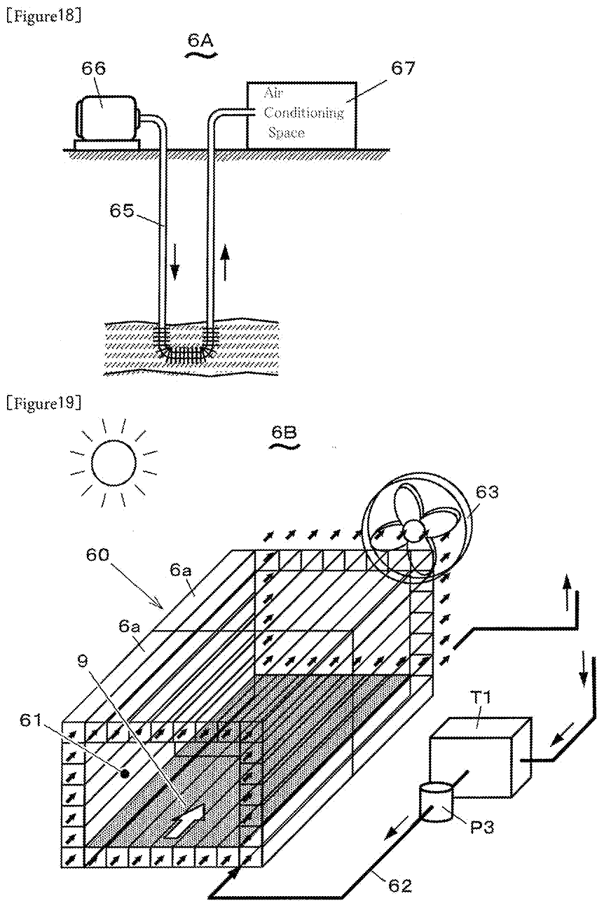

The cavity 61 is suitably used as an installation space for solar panels 64, as shown in FIG. 16. The solar panel 64 is an energy exchange device that converts the energy of sunlight into electrical energy. The solar panel 64 is located in a cavity 61 with four sides maintained at the temperature of groundwater by a fan 63. The solar panels are blown by a fan 63, so the panel surfaces can be maintained at a low temperature to maintain the power generation efficiency. In the structure, the shape of the cavity 61 can be made according to the contents to be stored in it, to optimize the temperature control of the contents and make it more efficient. For example, in the case of the solar panel 64 shown in FIG. 16, in order to be able to fit that panel in the smallest space, the hollow tube 6 It can be a sealed cavity 61 surrounded by a wall formed by a, or it can be a partially open, unsealed cavity 61.

Next, referring to FIG. 17, an application example of the energy utilization device 6 will be described. This energy utilization device 6 has a plurality of underground tanks T (three in the example shown in the figure), a mixer 6mx that mixes the underground water from each tank, and The underground tanks T are each connected to each other. The underground tanks T are individually buried at multiple depths to obtain groundwater of different temperatures t1, t2, and t3. The tanks are buried individually at multiple depths so that groundwater of different temperatures t1, t2, and t3 can be obtained. The mixer 6mx is used to mix the groundwater of different temperatures (t1, t2, t3) obtained from these multiple underground tanks T The mixer 6mx mixes groundwater of different temperatures t1, t2, and t3 from these multiple underground tanks T to deliver constant temperature groundwater that is adjusted to a predetermined temperature t0 regardless of the season. Even if there is a seasonal variation in the temperature of each groundwater, it can be maintained at the predetermined temperature by changing the mixing ratio to account for the temperature difference between the different groundwaters.

Next, referring to FIG. 18, an energy utilization device 6A according to one other embodiment, of the present invention will be described. The energy utilization device 6A is a device for utilizing energy in a constant temperature underground, and is provided with a hollow pipe 65 reciprocating between the underground and the surface at a predetermined depth at a predetermined constant temperature, and a fan 66 feeding air from the surface side to the hollow pipe 65. The hollow pipe is equipped with a fan 66 that feeds air from the surface side into the hollow pipe 65. The air that is fed into the hollow pipe 65 by the fan 66 and cooled or heated by heat exchange through heat release or absorption at a predetermined depth underground can be used for air conditioning on the surface side. The air can be used for air conditioning on the surface side.

In the basement, in order to facilitate heat exchange, the surface area of the pipes may be increased at the heat exchange location by installing a large number of fins on the pipes or by making the pipes with many branches. Although it varies depending on the latitude, in the Japanese main island of Honshu, the ground temperature is maintained at about 15 degrees Celsius at 5 meters underground throughout the year. For example, water can be stored in a tank 5 meters underground, and the cold temperature in summer and the warm temperature in winter can be transported to the desired location above ground using pipes, etc., and flowed into a structure such as one constructed by connecting plastic bottles. If there is a space around the liquid flow path, the air in the space will be close to the temperature of the liquid flowing around it. The path of the space can be configured to be as long and narrow as possible to ensure efficient heat exchange. (FIG. R1)

Next, referring to FIG. 19, an energy utilization device 6B according to one more embodiment of the present invention will be described. The energy utilization device 6B is a device using sunlight energy, and comprises a structure 60 having a hollow part 61 formed inside by connecting a plurality of hollow tubes 6a formed of light-permeable material. The device consists of a structure 60, in which a cavity is formed inside by connecting multiple hollow tubes 6a made of light-permeable materials, a pipe 6a for distributing water or hot water to the hollow tubes 6a of the structure, and a circulation pump P3, and a circulation pump P3 to distribute water or hot water in the hollow tube 6a of the structure, and to send air from one opening to the other in the cavity 61 formed by the structure 60. The cavity 61 formed by the structure 60 is equipped with a fan 63 that blows air from one opening to the other.

The structure 60 is installed in a place where it can receive sunlight, and seawater 9 is passed through the bottom side of the cavity 61 in plan view, and the wind by the fan 63 is passed through the top side of the seawater 9. The seawater 9 is passed through the bottom side of the cavity 61. This accelerates the evaporation of the seawater 9 and salt can be obtained.

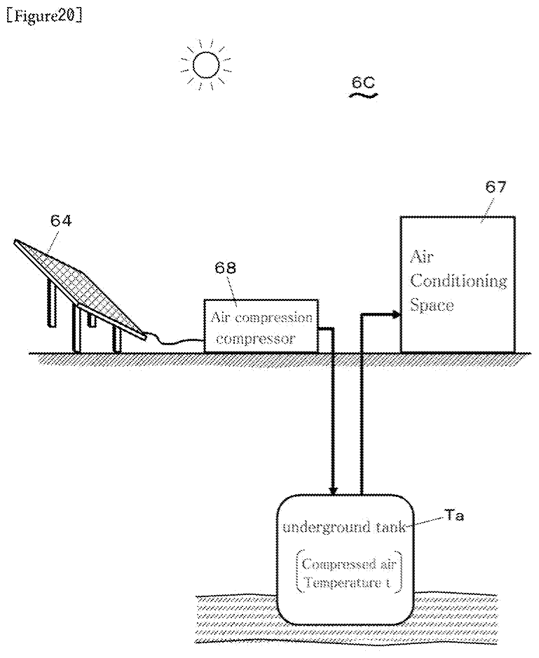

Next, referring to FIG. 20, an energy utilization device 6C according to yet another embodiment of the present invention will be described. The energy utilization device 6C is an energy utilization device 6C that uses compressed air for air conditioning, and includes an air compression compressor 68 powered by natural energy. The energy utilization device 6C is an energy utilization device 6C that uses compressed air for air conditioning, and is equipped with an air compression compressor 68 powered by natural energy, and a tank Ta buried underground that stores the air compressed by the air compression compressor 68. In this example, a solar panel 64 is provided to use sunlight as natural energy.

Compressed air, stored in tank Ta and temperature-controlled to a predetermined temperature, can be delivered through pipes to air-conditioned space 67 for use.

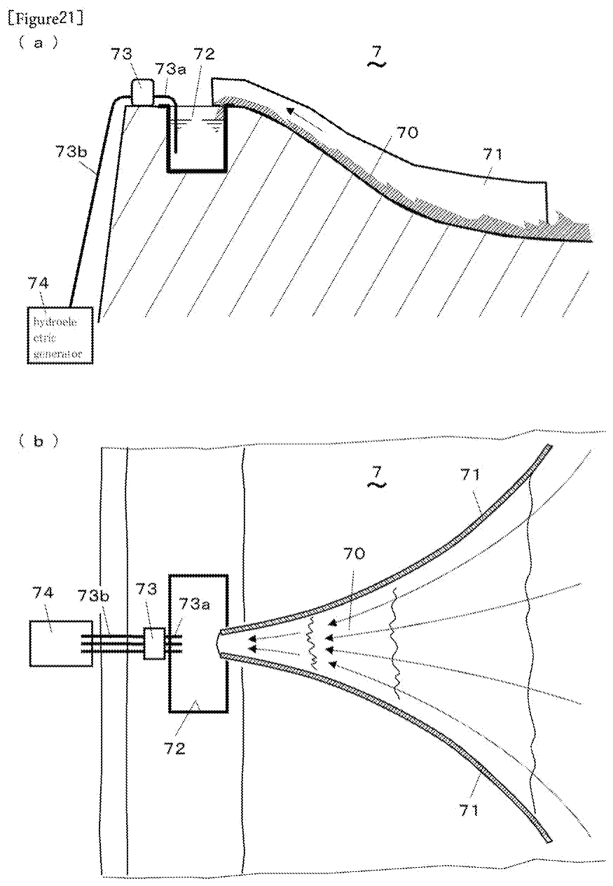

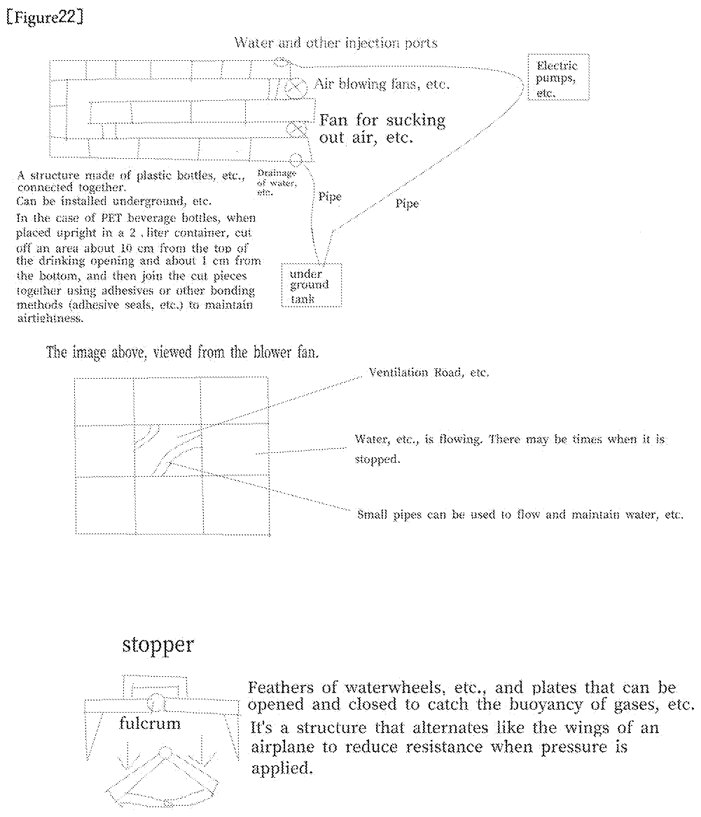

Next, with reference to FIG. 21, an energy utilization device 7 in accordance with yet another embodiment of the present invention will be described. The energy utilization device 7 is an energy utilization device 7 that generates electricity by using natural energy, and has a wall structure 71 installed on a coast that simulates a rias coast where seawater rises to a position higher than the sea surface by the force of ocean waves. 71, a wall structure 71 that simulates a rias coast where seawater rises to a position higher than the sea level due to the force of ocean waves, a tank 72 that introduces and stores the rising seawater 70, and a tank 72 that stores the seawater in the tank 72. The tank 72 is equipped with a hydroelectric generator 74 that generates electricity using the potential energy of the seawater 70 stored in the tank 72. The tank 72 is equipped with a hydroelectric generator 74 that generates electricity using the potential energy of the seawater stored in the tank 72.

Waves of seawater lapping at the shore run up the slope, their path narrowed by the funnel-like wall structure 71, and the seawater 70 flows into the tank 72. The seawater in the tank 72 is transported by pipes 73a, 73b and pumps 73 to the hydroelectric generator 74, 73 to start flowing toward the hydroelectric generator 74, and the flow is sustained downstream without a pump.

By replacing the hydroelectric generator 74 with an air compression compressor, instead of generating electricity, the potential energy can be stored as energy of pressure by using the potential energy to generate compressed air and store it in a tank. By replacing the hydroelectric generator 74 with an air compressor, instead of generating electricity, the potential energy is used to generate compressed air and store it in a tank.

The present invention is not limited to the above configuration, and various variations are possible. For example, the configurations of the above-mentioned embodiments can be combined with each other.

The following is a quotation from the basic application under which the priority is based.
Replace the wheels of trains with sleds and other vehicles that, carry objects such as goods. Instead of a railroad track, the width of the track should be just wide enough for the sled to pass through, and water should be placed in the area to cool and ice it using electricity or other means to reduce friction and energy loss. It is used for acceleration and deceleration by contacting wheels, etc. with the space between the rails.

The wheels can be retracted into the vehicle body using electricity to reduce resistance when speeding. The sled is designed to slide on the icy road surface, but the rail structure has a protruding shape to prevent sideways derailment. The sled may be equipped with tires that touch the sides of the rails to reduce impact on curves.
Design the route so that it descends gradually and uses gravitational energy to accelerate.

The route can be designed without any difference in elevation, but even if the route is an uphill route after calculating the cost of construction, the sled reduces friction, so the energy of inertia can be used as a source of energy to move objects to higher ground.

Even on a slight downward slope, the resistance of the contacting parts of the vehicle body is extremely low, so the vehicle can accelerate rapidly even when only a small amount of energy is given by the contacting tires.

The same can be said for linear motor cars and other vehicles that are not in contact with the ground. In addition, it is important to create as much of a vacuum as possible in the tunnels surrounding the cars to prevent air resistance from occurring. A method of opening a hatch on the car at a stop to create a passage to the outside, or a method of installing a door in the tunnel that can be opened and closed up and down, such as a separating hatch, to allow partial air to enter and exit the tunnel at a stop.

If rainwater enters the structure on the lane, which is cooled to keep the liquid in contact with the lane at a temperature with low resistance, a hollow hole is provided at the end of the lane to allow rainwater to flow out of the structure on the passage.

A roof should be attached to the top of the structure to protect it from rainwater and to shield everything around it. To shield the area, cover it with a transparent material that allows light to pass through, a strong plastic material, or a structure made by connecting PET bottles (or other special bottles). If water, etc., is pumped in from an underground tank located about, five meters underground where the temperature is maintained at about 1.5 degrees Celsius throughout the year (if it is underground in a mountainous area, it has the energy to fall naturally due to the pressure of gravity) and circulated, the space where cars, etc., can pass will be close to 1.5 degrees Celsius. and the flow rate of the liquid will be reduced. If you can adjust the flow rate of the liquid, you can save the cost of air conditioning. When the space where cars run is depressurized to make it close to a vacuum to reduce air resistance, pressure-resistant reinforced plastic or glass can be installed around the periphery of the space where cars run to reinforce it.

When water is circulated by a pump, it does not need to be pumped frequently because liquids such as water do not suddenly boil even when exposed to sunlight from outside, thus reducing energy costs. If energy is to be obtained from solar panels, solar panels can be installed on the roof, sides, lanes, or other open spaces of the facility.

In order to cool the solar panels, water that is kept at a certain temperature in an underground tank, as described above, can be poured over the panels, or a pipe-like structure made of a substance that conducts light can be installed nearby water from an underground tank, etc. to the solar panels.

For example, you can control the temperature, make the solar panels watertight and confidential, put the panels in a shallow water tank, and then pour water of about 15 degrees Celsius into the tank, which is about five meters underground. The water is then collected in an underground tank.

If the location is such that natural groundwater flows naturally, it can be poured and the temperature of the panels can be controlled.

For example, using a plastic bottle, cut off the mouth part of the bottle and glue several rectangular cubes together to create a structure that can hold water in an underground tank. Use a material that allows light to pass through but not water, such as a plastic bottle, to create a hollow structure that can hold water. The hollow part of the structure can be filled with solar panels or other devices to control the temperature. The same device can be used to increase the amount of electricity generated by solar panels installed in homes.

This is because solar panels generate less electricity when they get too hot. In addition, in order to efficiently air-condition the space, we will use water of about 15 degrees Celsius from the above underground tanks. The ground temperature around the underground tank varies depending on the depth, so multiple tanks can be installed at different depths, and the water can be mixed.

In the underground tank, water, etc., which is kept at about 15 degrees Celsius by the ground temperature, is placed in a structure with a pipe of about 5 centimeters in length and width (the reference scale can be changed freely) and a passage around the pipe through which water, etc., can flow. The water from the above underground tank will flow into the pipe, and a fan will be attached to the end of the pipe to blow air into the tank.

As the air moves through the pipe with the power of a fan, it exchanges heat with the surrounding water (for example, if it is made of a thin material such as a plastic bottle, the heat is easily conducted) and gradually cools down in summer. If the pipe is long enough, the temperature at the outlet of the pipe will be close to the temperature of the water from the underground tank. It will be cooler in summer and warmer when the air temperature is lower than about 15° C.

For example, plastic bottles can be connected together to make a structure. Fans such as electric fans consume little electricity, so they save energy.

The tube does not have to be straight, it can be curved to create distance. It is also possible to pass a narrower tube through the tube so that water can circulate through it, making it easier to exchange heat when a cold hits it. A metal rod with a high thermal conductivity can be placed between the pipe and the passage through which the circulating water is flowing to increase the temperature of the water around 15° C. and the area of contact with the flowing air.

Fans can be installed not only at the inlet of the pipe, but also at the outlet and in the middle of the pipe to increase the heat exchange efficiency. This system can be installed indoors, but it can also be installed at a constant ground temperature of about 5 meters underground. Air is pumped in and out using pipes. If air is fed into the pipe at a depth of about 5 meters below ground, where the ground temperature is about 15 degrees Celsius, the air that is sucked in at ground level will circulate underground in the summer, and when it exits the pipe, the temperature will drop to 15 degrees Celsius. The same is true in winter, when the temperature is close to the ground temperature of 15° C. Water flows through the pipe on all sides or in specific areas, but in the case of a two-tiered structure, the lower part of the pipe does not need to be sealed off from the ceiling, as water is maintained by gravity. If the ground temperature at the installation site is about 15 degrees Celsius, the temperature of the original air will be closer to 15 degrees Celsius.

Compressed air is used when hot water from a hot spring or artificially boiled water from a boiler is used for air conditioning in homes and facilities. First, the hot water is poured into a space made of plastic bottles, etc., and the temperature of the air, etc., is made closer to 15 degrees Celsius by heat exchange using the underground temperature of about 15 degrees Celsius in the above method. In order to keep it warm when you send it, you can put it in a crappy connected plastic bottle and compress it in the space enclosed by it. (or blow it around a little). The air is compressed (or blown around a little, depending on the situation).

The above space for hot air blowing can be installed underground or above ground, but if the ground is very cold, you can use a heat retention system using water in a tank about 5 meters underground at about 15 degrees Celsius, considering the cost of digging underground. However, if it is very cold above ground, you can use a heat retention system using water from a tank located about 5 meters underground at a temperature of about 15 degrees. The depth of the underground tank may vary depending on the time of year, so it is possible to prepare several tanks and mix the water. If necessary, cover the periphery of the device that sends the air made from the plastic bottles with a heat insulator (such as Styrofoam with heat insulation effect) to improve efficiency. It is also possible to send cold air.

A rectangular space is created by connecting PET bottles, etc., and a structure is created by connecting PET bottles, etc., inside the rectangular space. Then, liquid can be poured in as described above, and items to be dried or moistened can be placed in the space where air was sent in the above. At this time, the liquid can be packed tightly so that air does not lag behind, or it can be packed so that there is a certain amount of space through which warm air can flow. For example, if you want to extract salt by evaporating seawater, you can make a space for seawater, a space for hot air to flow over the seawater, and a plate-like passage made of plastic bottles (it can be slightly sloped) underneath the seawater, and a space for water to flow over it. Surrounded by plastic bottles, the entire interior can be pressurized with a compressor. The evaporation of seawater can be accelerated by the power of sunlight, or by running warm water through it, and warm air can be sent to accelerate the process. When the humidity becomes high, the compressor pressurized interior is returned to normal atmospheric pressure, and cold water from an underground tank or the like flows into the pipes. As the humidity drops and the temperature in the vicinity is cooled, water droplets from the air flow through the board and move to the lowest position. This structure will speed up the evaporation of seawater. The outer circumference of the plastic bottle can be covered with transparent film or plastic as necessary to withstand pressure.

When discharging the air inside the device to the outside, filters for salt damage prevention can be installed at the fans for air intake and discharge. Salt damage is caused by microscopic particles generated when waves break and carried up by the wind, so this device does not generate microscopic particles in the first place.

A hatch should be placed in the ventilated area to withstand the pressurization of the interior. The device can be made of transparent materials such as plastic bottles to efficiently transmit the power of sunlight. A black material (such as a black sheet) can be placed at the bottom of the device for more efficient use of sunlight energy. The device can also be placed in a space where sunlight is needed, such as a solar panel, to prevent the temperature of the solar panel from rising while obtaining salt.

The lower part of the device is made of a transparent material such as a plastic bottle, and the angle of the device is adjusted according to the angle of the solar panel.

When breeding fish, make the space a loop structure so that the fish do not collide with the wall of the space where the water is stored by accelerating in a near-vertical direction. As shown in the above figure, a space is created using a plastic bottle and water is placed in the space. The upper part of the space can also be covered with a lid made of plastic bottles or other materials. Then, a pump is used to suck out the water, which is then pressurized and spewed out, or compressed air is sent in one direction to give the water a constant rotation. The width of the looped structure where the fish are swimming should be about 50 to 100 centimeters (just a guide).

Normally, electric compressors are used to compress air for industrial purposes, but the energy of gears powered by hydraulic power is used to power the compressor, or the rotational energy of a windmill is transmitted by gears to power the compressor.

Then, a tank of compressed air is set up at a constant ground temperature of about five meters underground, or the air is blown into water in a tank set up five meters underground to bring the temperature down to 1 The temperature will be reduced to 1.5° C. Natural energy, such as water power, can be used to power an air compressor and stored in a cylinder installed underground, etc., so that it can be taken out at any time like a battery and used to move gears. When compressing air with a compressor, the air is first cooled in an underground tank and then compressed to adjust the humidity, or the air is stored underground to reduce the humidity. The temperature can also be lowered by storing tanks containing compressed air underground.

Even large tanks can be installed underground without any trouble. Using the system described above, the temperature and humidity of the compressed air can be adjusted, and the air can be distributed from the facility to households through underground pipes. Instead of storing electricity, it can be stored as compressed air (in the form of gas or dry ice). Waterwheel-like structures can be installed on the banks of rivers. If you have a rias coast, you can create an artificial structure to bring the seawater up to 10 meters above the coastline.

It is then stored and used to turn a hydroelectric turbine that uses gravity to generate electricity and power an air compressor.

The potential energy of large amounts of seawater can be obtained semi-permanently by using the energy of ocean waves to benefit human life. In this way, compressed air can be stored in cylinders, and the cylinders can be moved to a location 20 meters underground, or the cylinders can be stationary with a diameter of 20 meters. It can be considered.

Then, prepare a water tank filled with water, etc., installed underground. If a rotating wheel is placed in the tank and compressed air is supplied from below, the wheel will rotate by the energy generated when it rises to the surface. The deeper the water tank, the more wheels can be installed, and the buoyancy will provide energy for the waterwheel and wheels to rotate.

The rotational energy of the waterwheel and wheels can be used to run a compressor to produce compressed air and run a generator, which is very efficient. Compressed air (gas), dry ice, etc., and Omasa gas (HHO/GAS, etc.) are set at a deep point where water pressure is applied to a vertical tank filled with liquid water, etc. Electricity and heat from chemical reactions, etc., are applied to ignite Omasa gas, etc. (or a mixture of hydrogen and oxygen). The heat causes dry ice to expand as expected, and compressed air similarly generates kinetic energy upward against water pressure (gravity), which is applied to the waterwheel to turn it. This energy is then applied to waterwheels to turn them. The energy is then recovered to power generators.

In order to increase the efficiency of the rotation of a waterwheel, the wings of the waterwheel should be movable and can be opened and closed. In this way, the wings of the waterwheel can be opened when pushed by the gas to receive the kinetic energy of the liquid and prevent the rotation speed from decreasing due to resistance from the waterwheel wings. The wings can be opened and closed, but not completely, so that air can enter the wings and push them apart, or a plate can be attached to the wings of the waterwheel so that air can easily gather.

If a waterwheel of this shape is installed in a tunnel with water pressure without the energy of air or other gases rising, the wings will open when pushed by the water flow and close when the pressure of the water flow weakens. Some large dams and other hydroelectric power plants have a drop of 100 meters or hundreds of meters, but if the propeller for hydroelectric power generation is only attached to the downstream part of the dam, the energy of the water flow cannot be recovered sufficiently to turn the turbine of the generator. However, if the propellers are only attached to the downstream section, they will not be able to recover enough energy from the water flow to turn the turbine of the generator. In this way, the potential energy of the water flow can be efficiently recovered.

In addition, when compressed air, etc., is blown out from a deep place where water pressure is high, and when waterwheels are turned by the force of air, etc., climbing upward, the propeller, waterwheel, etc., will not decelerate due to water pressure if compressed gas, etc., is blown out in the vicinity of 1 o'clock when the waterwheel, etc., is rotating clockwise. Compressed gas is also spouted from the 6 o'clock direction, so that the clockwise rotation force is always maintained, and the energy of compressed air and gas and the buoyancy force due to the difference in density are converted into rotational energy of the waterwheel. When the shaft of the waterwheel is hollow and compressed gas is injected into the shaft, the hole in the shaft catches on the hole and the door opens, and when it reaches the position where there is no catch, the door closes by spring force. Gas can be passed through the hollow part of the shaft and covered with a cap made of metal, etc., so that when the gas outlet of the rotating shaft comes to a specific position when a specific part of the cap is open, gas can be spouted. It is also possible to link the compressed gas jet to the position of the waterwheel and control the valve so that compressed gas is emitted only when it reaches a specific position.

The shaft that transmits the energy of the waterwheel can be extended horizontally and passed through the tank to the part of the tank where there is no water to increase confidentiality and prevent water from coming out of the tank, or it can be changed in the tank using gears to transmit the rotation to the shaft that extends upward. Once it is high enough to make contact with the outside air at the top of the tank, the energy can be transferred to gears and used as a power source. A number of water wheels can be connected vertically There are many possible ways to extend the tank deep underground or to raise it above ground.

By taking advantage of the fact that the temperature in the vicinity of five meters below the surface of the Japanese mainland is maintained at about 15 degrees Celsius throughout the year, the energy required for cooling can be saved by grounding a tube-shaped tunnel there. It is also possible to ground the structure above ground and cover the periphery of the tube with liquid water for cooling, and if the periphery of the tube is made of plastic, glass, or other material that allows light to pass through, the view from inside the car can be seen.

The same tunnel can be filled with water to run a ship with a sealed interior, and the tunnel can be vacuumed to increase energy efficiency during travel. Energy costs can be reduced by using a similar structure for cars and other vehicles, even if they are not as large as trains. Increase the certainty of automatic car driving. Cars are connected to carriages installed on a similar platform, and the weight of the car is mainly taken up by the sled to reduce rolling resistance. A motor or other device that transmits power by contacting with the surface of the road may be incorporated in the dolly, or the power of the engine or motor of the car may be connected to the power unit, of the dolly from the tires, engine or motor of the car while the car is on the dolly. In addition, there are various ways to use existing cars and trucks. If the vehicle is a four-wheeled vehicle, two wheels can be attached to the center of the vehicle in advance, and the wheels will not come into contact with the ground during normal driving, but if the angle of the vehicle is changed by hydraulic pressure, or if the sugar is changed, the wheels will come into contact with the ground. However, by adopting a structure that allows the car to contact the ground if the angle, etc., is changed by hydraulic pressure, etc., or if the sugar is changed, etc., the four-wheel part is used to get on the dolly, etc., and the remaining two wheels, etc., (rubber, steel, etc., wheels, etc.) are made to contact the upper part of the cooling rail, etc., as necessary by hydraulic pressure, etc. The height of the car's tires can be changed to prevent contact with the ground. The bogie can be equipped with a motor that provides the driving force for running, or part of the bogie can be powered so that it can be pulled or pushed and connected to other bogies like a train, or a powered bogie can be placed in an appropriate location to reduce the installation cost. The movement of the bogies (units) can be monitored by sensors, and cameras can be installed around the cooling lanes so that the bogies can be controlled automatically and unattended. Solar panels can be installed near the space where the cooling lanes are installed, and electricity from the solar panels can be transmitted from the metal parts of the lanes to the motors of the bogies, or contactless power transmission can be used so that the lanes and the electrical receivers of the bogies do not have to be in direct contact. It is also possible to use a non-contact power transmission so that the lane and the electric receiver of the bogie do not have to contact each other directly. You can attach the device to the side of the tire of the car or other vehicle, and connect its rotation to the tire (or steel wheel) that can be installed on the bogie or other vehicle to prevent it from being installed on the road surface or the top of the cooling rail, which is free of ice, etc., and convert the energy of the engine, motor, etc. of the car into driving energy, etc.

It is possible to attach a device to the side of the tire of a car or other vehicle and connect its rotation to a tire or other vehicle (even if it is a steel wheel or something like that) that, can be installed on a cart or other vehicle to prevent it from being installed on top of a road surface or cooling rail that is free of ice, etc., and convert the energy of the engine, motor, etc. of the car into driving energy, etc.

There are multiple ways to do this. In order to prevent the road surface from freezing, water, which is kept at about 15 degrees Celsius by geothermal energy stored 5 meters underground, is led to the road surface by a pipe. The water should be collected and circulated by the motor pump. Stakes should be placed at the rear of the bogie for emergency stopping, and the bogie can be brought to a stop by lowering the stakes onto the road surface. Even in the case of obtaining energy in the direction of travel using technology such as linear motor cars, if the magnetic field of the linear motor car track is partially cooled and covered with ice, and if a sled or other device that reduces resistance is attached to the track, the power to float vertically using electricity can be saved and the energy in the direction of travel can be used. It is more efficient because it can concentrate most of the electrical energy on the direction of travel. The direction of the magnetic energy applied to the levitation energy and the energy to accelerate in the direction of travel of the linear motor car should be adjusted so that the balance of power consumption and speed during travel is maximized.

Even if the car does not practically float, it can run with less resistance because of the sled. A linear motor car can be equipped with a sled and the above power wheels. Create a vacuum in the tunnel to eliminate wind loss and reduce noise. The magnetic energy transmission part of the linear motor car and the sled device can be installed separately. In order to cool the area where the sled is in contact, a heat-absorbing plate from a freezer can be elongated and placed there, or a special heat-absorbing device can be used, or a large compressor and constant-temperature underground water can be used for efficient temperature control. The exhaust heat from the compressor could be used secondarily to run a Stirling engine. The compressor can be installed in a space where water is drawn from 5 meters underground and circulates around it using pipes, etc., for heat exhaustion measures.

In order to prevent the road surface from freezing and to reduce the temperature of the road surface in summer, water in a tank installed 5 meters underground at the bottom of the road or passage can be circulated through pipes to 10 cm below the asphalt surface. The water is then circulated 10 cm below the asphalt to prevent the road surface from freezing or overheating. The water can also be circulated around the sleigh to increase the cooling efficiency in summer. Use plastic bottles to create a space the size of a futon (it can be larger or smaller, and the size can be changed) to keep the temperature in the space cool in summer and not freezing in winter. The water from the tank, which is located about 5 meters underground, is fed into the PET bottles through pipes, and the PET bottles are connected so that the water circulates and returns to the tank. The water can be pumped using a motor, installed underground in a high mountain, or in a large underground tank linked to a large facility such as a water purification plant, where the temperature is close to 15 degrees Celsius even in summer, and sent to each household. The cooling rails (lanes) can be covered with an airtight cover to reduce the cost of the cooling tower by circulating the underground tank water at about 15° C. The upper cover of the cooling rails and lanes is electrically closed during the summer to prevent heat buildup, but can be opened and closed automatically by a motor or other device that detects when vehicles are passing through. When freezing water or other liquids in a cooling lane, compressed air (carbon dioxide) or gas can be sent through pipes inside the liquid or ice to cool it by vaporization heat.

Replace the wheels of trains with sleds and other vehicles that carry objects such as goods. The width of the rails should be just wide enough for the sled to pass through, and water should be placed on the rails to cool and ice them using electricity or other means to reduce friction and energy loss. Wheels are placed between the rails and used for acceleration and deceleration. The wheels can be retracted into the body of the vehicle using electricity to prevent contact with the ground to reduce resistance when speeding up. The sled is made of rails that protrude from the ground to prevent the wheels from falling off. The sled may be equipped with tires that touch the sides of the rails to reduce impact on curves.

We can design the route to go down gradually and use gravitational energy to accelerate the object. It is possible to design the route without any (difference in elevation, but even if the route is uphill due to the cost of construction, the energy of inertia can be used as the source of energy to move the object to higher ground because friction is reduced by the sled. Even on a slight downward slope, the resistance of the contacting parts of the vehicle body is extremely low, so the vehicle can accelerate rapidly even if only a small amount of energy is given by the contacting tires. The same can be said for linear motor cars and other vehicles that are not in contact with the ground.

In addition, the tunnel surrounding the vehicle should be kept in a vacuum to prevent air resistance from occurring. There are several ways to prevent air resistance, such as opening the hatch on the vehicle when it arrives at a stop, or installing a door in the tunnel that can be opened and closed by a separating hatch or other means, such as up and down, to allow partial air to enter and exit the tunnel at the stop.

By taking advantage of the fact that the temperature in the vicinity of five meters below the surface of Japan's mainland is maintained at about 15 degrees Celsius throughout the year, the energy required for cooling can be saved by grounding a tube-shaped tunnel there. It is also possible to ground the structure above ground and cover the periphery of the tube with liquid water for cooling, and if the periphery of the tube is made of plastic, glass, or other material that allows light to pass through, the view from inside the car can be seen.

The same tunnel can be filled with water to run a ship with a sealed interior, and the tunnel can be vacuumed to increase energy efficiency during travel. Energy costs can be reduced by using a similar structure for cars and other vehicles, even if they are not as large as trains. Increase the certainty of automatic car driving. Cars are connected to carriages installed on a similar platform, and the weight of the car is mainly taken up by the sled to reduce rolling resistance. A motor or other device that transmits power by contacting with the surface of the road may be incorporated in the dolly, or the power of the engine or motor of the car may be connected to the power unit of the dolly from the tires, engine or motor of the car while the car is on the dolly. In addition, there are various ways to transmit the rotational force of the wheels to the road surface, etc.

In the case of a four-wheeled vehicle, two wheels can be attached to the center of the vehicle in advance, and the vehicle will not come into contact with the ground during normal driving, but will come into contact with the ground if the angle is changed by hydraulic pressure. In addition, the dolly can be equipped with a hydraulic jack so that the car on the dolly can be raised or lowered by hydraulic pressure after the car is mounted on the dolly, thereby changing the height of the car tires and preventing them from contacting the ground.

It is also possible to use a device on the side of the tires of a car or other vehicle to convert the energy of the car's engine, motor, etc. into driving energy, etc., by connecting it to the tires, etc., which can prevent the rotation of the tires from being set up against the road surface on the dolly, etc., or to convert the energy of the car's engine, motor, etc., into driving energy, etc., on the spot, without changing the position of the car as it passes through inspection. There are several ways to connect a device with a roller part, that rotates underneath the vehicle when the engine is rotated and the tires are rotated, to a wheel with a mechanism that can change the rotational energy of the roller part so that the wheels of the vehicle do not contact the road surface. In order to prevent the road surface from freezing, water, which is kept at about 15 degrees Celsius by geothermal energy stored 5 meters underground, is led to the road surface by a pipe. The water should be collected and circulated by the motor pump. Stakes should be placed at the rear of the cart for emergency stopping, and the cart can be lowered onto the road surface to stop the machine as soon as necessary.

If the magnetic field of the linear motor car track is partially cooled and covered with ice, and a sled is attached to the magnetic field, the power to float vertically can be saved and the electrical energy can be concentrated on the horizontal energy. If the sled is installed in a way that ice covers it, it will save the power to float vertically and concentrate the electrical energy in the horizontal direction.

The direction of the magnetic energy applied to the levitation energy and the energy to accelerate in the direction of travel of the linear motor car can be adjusted to save as much electrical energy as possible. A linear motor car can be equipped with a sled and the above power wheels. Create a near vacuum in the tunnel to eliminate wind loss and reduce noise. The magnetic energy transmission part of the linear motorcar and the sled device can be installed separately. In order to cool the area where the sled is in contact, a heat-absorbing plate from a freezer can be elongated and placed there, or a special heat-absorbing device can be used, or a large compressor and constant-temperature underground water can be used for efficient temperature control. The exhaust heat from the compressor could be used secondarily to run a Stirling engine. The compressor could be installed in a space where water is drawn from 5 meters underground and circulates around it using pipes. In order to prevent the road surface from freezing and to lower the temperature of the road surface in the summer, the water in the tank installed 5 meters underground at the bottom of the road or passage is circulated under the tank using pipes to prevent the road surface from freezing and from overheating. Water can also be circulated around the sledding area using pipes to increase cooling efficiency in summer. Use plastic bottles to create a space the size of a futon (it can be larger or smaller, and the size can be changed) to keep the temperature in the space cool in summer and not freezing in winter. Water from a tank installed about 5 meters underground is fed through a pipe into a plastic bottle, and the bottles are connected so that the water circulates and returns to the tank.

The water can be pumped using motors, installed underground in high mountains, or in large underground tanks linked to large facilities such as water purification plants, where the temperature is close to 15 degrees Celsius even in the summer, and sent to households.

### EXPLANATION OF THE SIGN

1 Energy Conversion Device
10 Liquid
11 Liquid Tank
11k Upper opening
11w continuous opening
11A Water seal tank
12 Gas receiving section
12a Movable vane
13 Nozzle
14 Gas cylinders
14a Valve
3 Output method
3a, 3c, 3e Coupler
3b, 3d, 3f Shaft
31 Power mechanism
31a Belt
31b Gears
4 Recovery device
5 Compressed gas generator
52 Pressurized piston
52b Sealant
36
54 Heat exchanger
2 Vehicle movement device
2a Ice surface
20 Road surface
21 Car body
22 Sleigh
23 Rail
24 Wheels (drive unit)
6, 6A, 6B, 6C, 7 Energy utilization equipment
6a Hollow tube
60 Structures
61 Cavity
62 Pipe
63 Fan
64 Solar panels
65 Hollow pipe
66 Fan
67 Air conditioning space
68 Air compression compressor
70 Seawater
71 Wall structure
72 Tank
74 Hydroelectric generator
9 Seawater
P3 Circulation pump
T Underground tank
Ta Tank
37
R1 Heat exchange system
38

1. An energy conversion device comprising: a liquid tank in which liquid is stored;
a plurality of gas receiving sections installed vertically in said liquid tank that can rotate or move up and down freely:
a nozzle in said liquid tank that ejects compressed gas from below said gas receiving section located at the bottom;
a gas cylinder that stores said compressed gas and delivers said compressed gas to said nozzle as a primary energy source; and
an output device that outputs the kinetic energy of rotation or upward movement generated in the gas receiving section by the buoyancy force generated by the gas receiving section receiving the compressed gas ejected from the nozzle to the outside of the liquid tank as secondary energy:
wherein the energy conversion device is characterized by the following: an output device that outputs the kinetic energy of rotation or upward movement to the outside of the liquid tank as secondary energy; and a recovery device that returns the gas from the liquid tank to the gas cylinder.

2. The gas cylinder is connected to a compressed gas generator that uses natural energy to generate compressed gas.

3. The gas cylinder can be used to produce dry ice (butane, etc.) by the heat of combustion of a mixture of gas containing hydrogen and oxygen. Any substance with similar properties can be substituted. The energy conversion device as claimed in claim 1 or 2 is connected to a compressed gas generator that produces said compressed gas by volumetric expansion of the gas.

4. The gas receiving section as claimed in claim 1 consists of movable wings that can be opened and closed, and is open when it receives compressed gas ejected from the nozzle and generates buoyancy, and is closed when it does not receive compressed gas and does not generate buoyancy.

5. The gas cylinder as claimed in claim 1 ejects compressed gas from the nozzle through a valve that is controlled to open and close, and the valve is controlled to open only when the gas receiving section is in a predetermined position.

6. The output means as claimed in claim 1 includes a power mechanism with a belt on which a plurality of gas receiving sections are distributed in a ring shape, and a gear over which the belt is bridged and which is rotated by the movement of the belt. An energy conversion device as claimed in any one paragraph.

7. A liquid tank as claimed in claim 1 having a connecting opening in communication with the interior of said liquid tank and an upper opening upwardly is provided on the lateral exterior of said liquid tank, said output means having a coupler and a shaft transmitting the rotation of said gear of said power mechanism in the space where said liquid tank and said water-filled tank are in communication.

8. The gas cylinder as claimed in claim 1 is connected to a compressed gas generator that generates the compressed gas by heating the gas by passing the gas piping through a heat exchanger, or by pressurizing the gas with a pressurized piston having a floating ring-shaped O-ring as a sealant that can adjust the internal pressure and the energy conversion device is connected to a compressed gas generator, which generates the compressed gas by pressurizing the gas with a pressurized piston having a floating ring-shaped O-ring as a sealant that can adjust the internal pressure.

9. The energy conversion device as claimed in claim 1, wherein a plurality of the liquid tanks are provided in parallel or series with respect to the gas cylinder.

10. A vehicle body moving device, comprising a vehicle body, a sled for sliding on ice provided on the front, rear, left and right sides of the underside of the vehicle body, rails with an ice surface formed by freezing liquid, which are provided on the road surface and guide the sled's sliding on ice, and a driving device to run the vehicle body.

11. The moving device as claimed in claim 10 is a wheel powered by an engine or motor mounted on the vehicle body, and the wheel is provided so that it can be raised and lowered with respect to the vehicle body so that it contacts the road surface when driven and leaves the road surface when not driven.

12. The driving device is a jet propulsion system or propeller propulsion system mounted on the vehicle body.

13. The drive unit is a linear motor, and the line forming the magnetic field of the linear motor has an ice surface formed by freezing a liquid to cover its surface.

14. The drive unit is a linear motor and a wheel that is driven by an engine or motor mounted on the vehicle body.

15. A device for utilizing energy from thermostated groundwater, comprising: an underground tank for storing thermostated groundwater buried in a predetermined underground location from which the thermostated groundwater can be obtained; a structure comprising a plurality of hollow tubes made of a light-permeable material connected to each other to form an internal cavity; and a pipe and a circulation pump for distributing the thermostated groundwater stored in the underground tank to the hollow tubes of the structure. The structure is equipped with a pipe and a circulation pump for distributing the constant-temperature groundwater stored in the underground tank to the hollow tubes of the structure, and a fan for blowing air from one end to the other of the cavity formed by the structure. The energy utilization device is characterized by the fact that it is an air conditioning space or an energy exchange equipment installation space.

16. The energy exchange device is a solar panel.

17. There is a plurality of underground tanks, which are individually buried at multiple depths underground, and the groundwater of different temperatures obtained from these plurality of underground tanks is mixed to obtain groundwater of a predetermined constant temperature regardless of the season. An energy utilization device as described in 5.

18. An energy utilization device that utilizes energy in the subsurface at a constant temperature, comprising a hollow pipe that reciprocates between the subsurface and the surface at a predetermined depth at a predetermined constant temperature, and a fan that feeds air from the surface side into the hollow pipe. The air cooled or heated underground at the specified depth by the fan is used for air conditioning on the surface side.

19. The structure consists of a plurality of hollow tubes made of light-permeable material, which are connected to form a cavity inside, a pipe and a circulation pump for distributing water or hot water to the hollow tubes of the structure, and a fan for blowing air from one opening to another opening in the cavity formed by the structure. The structure is installed in a place where it can receive sunlight, and seawater is passed through the bottom side of the cavity, and the wind from the fan is passed over the top of the seawater to promote evaporation of the seawater and obtain salt. This is an energy utilization device.

20. An energy utilization device that uses compressed air for air conditioning, comprising an air compression compressor powered by natural energy, and a tank buried underground that stores the air compressed by the air compression compressor, and delivers the temperature-controlled compressed air stored in the tank to the air conditioning space through pipes. The compressed air stored in the tank and adjusted in temperature is delivered to the air conditioning space through pipes.

21. An energy utilization device that generates electricity by using natural energy, comprising: a wall structure installed on the coast that simulates a rias coast where seawater rises to a position higher than the sea surface due to the force of ocean waves; a tank that introduces and stores the seawater that has been raised by the wall structure; and a hydroelectric generator or air (gas) compression compressor that generates electricity by using the potential energy of the seawater stored in the tank. The tank is equipped with a hydroelectric generator or an air (gas) compression compressor that generates electricity using the potential energy of the seawater stored in the tank.
[When breeding fish, make the space into a loop structure so that the fish do not collide with the wall of the space where the water is stored by accelerating in a near-vertical direction. As shown in the above figure, a space is created using a plastic bottle and water is placed in the space. The upper part of the space can also be covered with a lid made of plastic bottles or other materials. Then, a pump is used to suck out the water, which is then pressurized and spewed out, or compressed air is sent in one direction to give the water a constant rotation. The width of the looped structure where the fish are swimming should be about 50 to 100 centimeters (just a guide).

22. A device that moves on a cooling rail is used as a dolly and a car or other object is placed on it.
Multiple bogies can be connected. Some of the bogies can run on their own, while others can be connected and run only. The bogies can be controlled by a computer to run automatically and reach their destination without any human intervention.
summary document

23. The energy conversion device 1 consists of a liquid tank 11 in which liquid 10 is stored, a plurality of gas receiving sections 12 that are installed vertically in the liquid tank 11 and can rotate or move vertically. The energy conversion device 1 consists of a liquid tank 11 in which liquid 10 is stored, multiple gas receiving sections 12 installed vertically in the liquid tank 11 that can be rotated or moved vertically, nozzles 13 that blow compressed gas from below the gas receiving section 12 located at the bottom in the liquid tank 11, and nozzles 14 that store compressed gas as a primary energy source and blow compressed gas from below the gas receiving section 12. In the liquid tank 11, there is a nozzle 13 that ejects compressed gas from below the gas receiving section 12 located at the bottom, a gas cylinder 14 that stores compressed gas as a primary energy source and delivers compressed gas to the nozzle 13, and a gas receiving section 12 that receives compressed gas from the nozzle 13. The gas receiving section 12 receives compressed gas ejected from the nozzle 13, and the buoyancy force generated in the gas receiving section 12 by the buoyancy force generated when the gas receiving section 12 receives compressed gas from the nozzle 13, and the output means 3 that outputs the kinetic energy of rotation or upward movement to the outside of the liquid tank 11 as secondary energy 11, and a recovery device 4 that returns the gas from the liquid tank 11 to the gas cylinder 14.
